(19) United States
(12) Patent Application Publication
(10) Pub. No.: US 2026/0311045 A1
(43) Pub. Date: Oct. 8, 2026

(54) COMPUTING SYSTEM AND METHOD FOR CREATING A MACHINE LEARNING MODEL HAVING IMPROVED FAIRNESS

(71) Applicant: Capital One Financial Corporation, McLean, VA (US)

(72) Inventors: Alexey Miroshnikov, Scottsdale, AZ (US); Ryan Franks, Deerfield, IL (US)

(21) Appl. No.: 19/182,452

(22) Filed: Apr. 17, 2025

Related U.S. Application Data
(60) Provisional application No. 63/781,092, filed on Mar. 31, 2025.

(51) Int. Cl. G06N 20/00

(52) U.S. Cl. CPC G06N 20/00

(57) ABSTRACT

A computing platform installed with executable software for producing a fairer version of a machine learning model comprising a perturbed version of additive explanations for the model's features in which the additive explanations are perturbed by corresponding perturbation coefficients, where the computing platform is programmed to (i) produce candidates for the perturbation coefficients by carrying out a training process for a trainable object comprising the perturbation coefficients as trainable parameters, where the training process uses an objective function having an error term, a bias term, and a bias coefficient and involves multiple training rounds that are carried out using different bias-coefficient values and produce different candidates for the perturbation coefficients, (ii) evaluate the performance and bias achieved by the different candidates for the perturbation coefficients, and (iii) based on the evaluation, determine a given candidate for the coefficient values to use in the fairer version of the machine learning model.

### CROSS-REFERENCE TO RELATED APPLICATIONS

This application claims priority under 35 U.S.C. § 119 (e) to U.S. Provisional Application No. 63/781,092, filed on Mar. 31, 2025 and entitled “EXPLAINABLE POST-TRAINING BIAS MITIGATION WITH DISTRIBUTION-BASED FAIRNESS METRICS,” which is incorporated by reference herein in its entirety.

### BACKGROUND

Whenever a company's business requires business decisions to be made with respect to particular individuals, such as decisions as to whether to extend certain services or offer certain financial terms to particular individuals, there is a risk that the company's decision-making practices could incorporate some form of bias, whether intentionally or inadvertently. For instance, a company's decision-making practices may be at risk of incorporating a bias that unfairly favors individuals belonging to one subpopulation over individuals belonging to one or more other subpopulations. The distinction between different subpopulations of individuals (which may sometimes be referred to as different “groups” or “classes” of individuals) may be defined based on any of various attributes, examples of which may include gender, race, age, sexual orientation, gender identity, religion, and/or marital status, among other possibilities.

In view of this risk of possible bias, various regulations now exist that prohibit companies from engaging in decision-making practices that unfairly favor individuals belonging to one subpopulation over individuals belonging to one or more other subpopulations. In some cases, these regulations may prohibit decision-making practices that unfairly favor any one subpopulation of individuals over another, regardless of the legal status of the subpopulations, while in other cases, these regulations may be specifically focused on protecting certain legally-protected subpopulations of individuals, such as minorities, females, older age groups, etc., as compared to other subpopulations.

One example of such a regulation is the Equal Credit Opportunity Act (ECOA), which prohibits companies that extend credit from discriminating against individuals seeking credit based on attributes such as gender, race, color, religion, national origin, marital status, age, public assistance, or the exercise of any rights under the Consumer Credit Protection Act. Under the ECOA, a company that extends credit must undergo something called a fair lending review during which the company's decision-making practices are evaluated to ensure compliance the anti-discriminatory provisions of the ECOA, and if those decision-making practices incorporate any improper bias, the company must then alter its decision-making practices to mitigate that bias.

Along similar lines, a company may need to review its decision-making practices for improper bias (and potentially mitigate that bias) in order to ensure compliance with other applicable regulations and/or internal company policies, among other possibilities.

### Overview

Disclosed herein is new technology for producing a fairer version of a trained machine learning model (i.e., a machine learning model having reduced bias) that improves upon prior technology for reducing the bias of a trained machine learning model.

In one aspect, the disclosed technology may take the form of a method to be carried out by a computing platform that involves (i) defining a perturbed version of a machine learning model that was trained by applying a machine learning process to a training dataset, where (a) the machine learning model is configured to receive values for an input set of features and output a prediction and (b) the perturbed version of the machine learning model comprises a perturbed version of additive explanations for at least a subset of the input set of features in which the additive explanations are perturbed by a set of perturbation coefficients, (ii) determining, for each of at least a subset of the training records in the training dataset, a respective set of values that are based on additive-explanation values for the training record, (iii) defining a trainable object corresponding to the perturbed version of the additive explanations, where the trainable object is configured to (a) receive an input set of values that are based on additive-explanation values for an input record and (b) produce and output a perturbed version of the input set of values by applying a set of coefficients to the input set of values, (iv) producing multiple sets of candidate values for the perturbation coefficients by carrying out a training process for the trainable object using the respective sets of values determined for the training records and an objective function for the perturbed version of the machine learning model that includes (a) an error term that quantifies the error of the perturbed version of the machine learning model, (b) a bias term that quantifies the bias of the perturbed model with respect to certain distinct subpopulations, and (c) a bias coefficient that is applied to the bias term, where the perturbed version of the additive explanations is replaced by the trainable object during evaluation of the objective function, and where the training process involves multiple training rounds that are each carried out using a respective candidate value of the bias coefficient and each produces a respective set of candidate values for the perturbation coefficients; (v) based on an evaluation of the multiple sets of candidate values for the perturbation coefficients, determining a given set of values for the perturbation coefficients that are to be included in the perturbed version of the machine learning model, and (vi) outputting a given instance of the perturbed version of the machine learning model that includes the given set of values for the perturbation coefficients.

Thereafter, the given instance of the perturbed version of the machine learning model may be deemed to be a fairer version of the machine learning model, and may be deployed and utilized to render predictions of a given type for individuals or other entities within a population comprising distinct subpopulations that may give rise to bias concerns. Further, in at least some implementations, the given instance of the perturbed version of the machine learning model may be explainable, which may enable a model explainability technique to be utilized to explain the predictions of the given instance of the perturbed version of the machine learning model.

The additive explanations for at least the subset of the input set of features may take any of various forms, and in at least some embodiments, the additive explanations may comprise additive explanations that are produced using a game-theoretic explainability technique.

Further, the respective set of values that are determined for each of the subset of training records, the input set of values that is received by the trainable object, and the set of coefficients that is applied by the trainable object may each take any of various forms. For example, in at least some embodiments, (a) the respective set of values that are determined for each of the subset of training records may comprise additive-explanation values that are determined for the training record using a model explanability technique, (b) the input set of values that is received by the trainable object may comprise additive-explanation values that are determined for the input record using the model explanability technique, and (c) the set of coefficients that is applied by the trainable object may comprise the set of perturbation coefficients. As another example, in at least some embodiments, (a) the respective set of values that are determined for each of the subset of training records may comprise a dimensionality-reduced version of the additive-explanation values that are determined for the training record using the model explanability technique, (b) the input set of values that is received by the trainable object may comprise a reduced-dimensionality version of the additive-explanation values that are determined for the input record using the model explanability technique, and (c) the set of coefficients that is applied by the trainable object may comprise a dimensionality-reduced version of the set of perturbation coefficients.

Further yet, the trainable object may take any of various forms, and in at least some embodiments, the trainable object may comprise a neural network implemented using a machine learning framework that provides for automatic differentiation (e.g., a TensorFlow framework).

Further yet, the training process for the trainable object may take any of various forms, and in at least some embodiments, the training process may involve training rounds that each carried out by utilizing a gradient descent process (e.g., stochastic gradient descent) to minimize the objective function.

Still further, the evaluation of the multiple sets of candidate values for the perturbation coefficients may take any of various forms, and in at least some embodiments, the evaluation of the multiple sets of candidate values for the perturbation coefficients may involve (i) producing multiple instances of the perturbed version of the machine learning model that each has a respective one of the multiple sets of candidate values for the perturbation coefficients and (ii) evaluating performance and bias of the multiple instances of the perturbed version of the machine learning model.

In another aspect, disclosed herein is a computing platform that includes a communication interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 is a simplified block diagram illustrating an example computing environment in which a data science model such as a machine learning model may be trained and/or executed.

FIG. 2 is a simplified block diagram illustrating an example software-based pipeline for creating a machine learning model having reduced bias in accordance with the present disclosure.

FIG. 3 illustrated is a two-dimensional graph that illustrates one representative example of performance and bias values that may be determined for instances of a perturbed version of a machine learning model constructed in accordance with the present disclosure.

FIG. 4 is a flow chart that illustrates one possible example of functionality for creating a machine learning model having reduced bias in accordance with the present disclosure.

FIG. 5 is a simplified block diagram that illustrates some structural components of an example computing platform.

### DETAILED DESCRIPTION

Organizations in various industries have begun to utilize data science models to help make certain business decisions with respect to prospective or existing customers of those companies. For instance, as one possibility, an organization may utilize a data science model to help make decisions regarding whether to extend a service provided by that organization to a particular individual. One example may be an organization that provides financial services such as loans, credit card accounts, bank account, or the like, which may utilize a data science model to help make decisions regarding whether to extend one of these financial services to a particular individual (e.g., by deciding whether to approve or deny an application submitted by the individual). As another possibility, an organization may utilize a data science model to help make decisions regarding whether to target a particular individual when engaging in marketing of a good and/or service that is provided by the company. As yet another possibility, a company may utilize a data science model to help make decisions regarding what terms to offer a particular individual for a service provided by the organization, such as what interest rate level to offer a particular individual for a new loan or a new credit card account. Many other examples are possible as well.

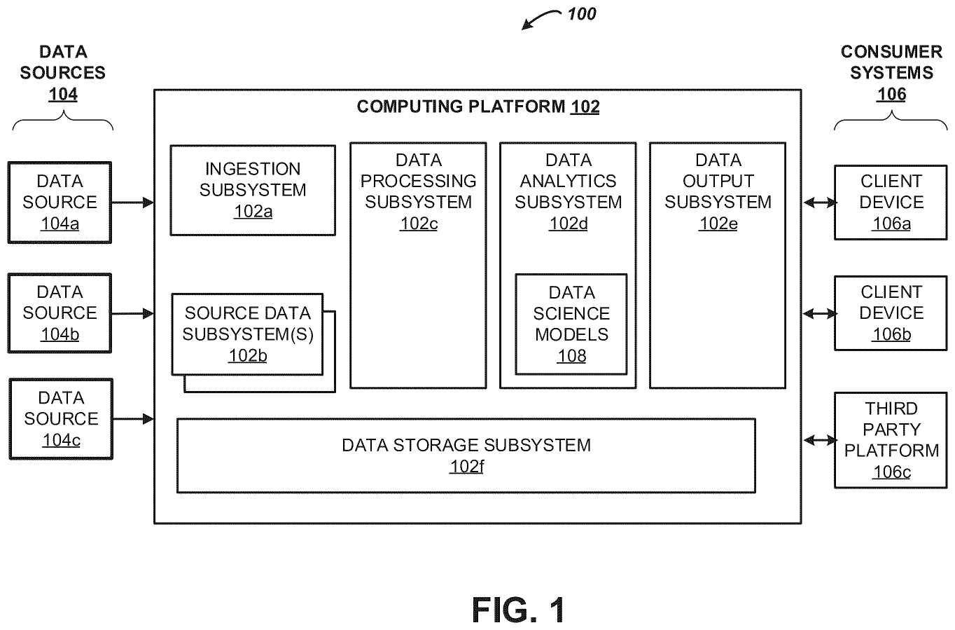

One illustrative example of a computing environment 100 in which an example data science model such as this may be utilized is shown in FIG. 1. As shown, the example computing environment 100 may include a computing platform 102 associated with a given organization, which may comprise various functional subsystems that are each configured to perform certain functions in order to facilitate tasks such as data ingestion, data generation, data processing, data analytics, data storage, and/or data output. These functional subsystems may take various forms.

For instance, as shown in FIG. 1, the example computing platform 102 may comprise an ingestion subsystem 102a that is generally configured to ingest source data from a particular set of data sources 104, such as the three representative data sources 104a, 104b, and 104c shown in FIG. 1, over respective communication paths. These data sources 104 may take any of various forms, which may depend at least in part on the type of organization operating the example computing platform 102.

Further, as shown in FIG. 1, the example computing platform 102 may comprise one or more source data subsystems 102b that are configured to internally generate and output source data that is consumed by the example computing platform 102. These source data subsystems 102b may take any of various forms, which may depend at least in part on the type of organization operating the example computing platform 102.

Further yet, as shown in FIG. 1, the example computing platform 102 may comprise a data processing subsystem 102c that is configured to carry out certain types of processing operations on the source data. These processing operations could take any of various forms, including but not limited to data preparation, transformation, and/or integration operations such as validation, cleansing, deduplication, filtering, aggregation, summarization, enrichment, restructuring, reformatting, translation, mapping, etc.

Still further, as shown in FIG. 1, the example computing platform 102 may comprise a data analytics subsystem 102d that is configured to carry out certain types of data analytics operations based on the processed data in order to derive insights, which may depend at least in part on the type of organization operating the example computing platform 102. For instance, in line with the present disclosure, data analytics subsystem 102d may be configured to execute data science models 108 for rendering decisions related to the organization's business, such as a data science model for deciding whether to extend a service being offered by the organization to an individual within a population comprising one or more protected subpopulations (e.g., a financial service such as a loan, a credit card account, a bank account, etc.), a data science model for deciding whether to target an individual within a population comprising one or more protected subpopulations when engaging in marketing of a good and/or service that is offered by the organization, and/or a data science model for deciding what terms to extend an individual within a population comprising one or more protected subpopulations for a service being offered by the organization, among various other possibilities. In practice, each such data science model 108 may comprise a machine learning model that was trained by applying a machine learning process to a training dataset, although it should be understood that a data science model could take various other forms as well.

Referring again to FIG. 1, the example computing platform 102 may also comprise a data output subsystem 102e that is configured to output data (e.g., processed data and/or derived insights) to certain consumer systems 106 over respective communication paths. These consumer systems 106 may take any of various forms.

For instance, as one possibility, the data output subsystem 102e may be configured to output certain data to client devices that are running software applications for accessing and interacting with the example computing platform 102, such as the two representative client devices 106a and 106b shown in FIG. 1, each of which may take the form of a desktop computer, a laptop, a netbook, a tablet, a smartphone, or a personal digital assistant (PDA), among other possibilities. These client devices may be associated with any of various different types of users, examples of which may include individuals that work for or with the organization (e.g., employees, contractors, etc.) and/or individuals seeking to obtain goods and/or services from the organization. As another possibility, the data output subsystem 102e may be configured to output certain data to other third-party platforms, such as the representative third-party platform 106c shown in FIG. 1.

In order to facilitate this functionality for outputting data to the consumer systems 106, the data output subsystem 102e may comprise one or more Application Programming Interface (APIs) that can be used to interact with and output certain data to the consumer systems 106 over a data network, and perhaps also an application service subsystem that is configured to drive the software applications running on the client devices, among other possibilities.

The data output subsystem 102e may be configured to output data to other types of consumer systems 106 as well.

Referring once more to FIG. 1, the example computing platform 102 may also comprise a data storage subsystem 102f that is configured to store all of the different data within the example computing platform 102, including but not limited to the source data, the processed data, and the derived insights. In practice, this data storage subsystem 102f may comprise several different data stores that are configured to store different categories of data. For instance, although not shown in FIG. 1, this data storage subsystem 102f may comprise one set of data stores for storing source data and another set of data stores for storing processed data and derived insights. However, the data storage subsystem 102f may be structured in various other manners as well. Further, the data stores within the data storage subsystem 102f could take any of various forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities.

The example computing platform 102 may comprise various other functional subsystems and take various other forms as well.

In practice, the example computing platform 102 may generally comprise some set of physical computing resources (e.g., processors, data storage, communication interfaces, etc.) that are utilized to implement the functional subsystems discussed herein. This set of physical computing resources take any of various forms. As one possibility, the computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the example computing platform 102 may comprise “on-premises” computing resources of the organization that operates the example computing platform 102 (e.g., organization-owned servers). As yet another possibility, the example computing platform 102 may comprise a combination of cloud computing resources and on-premises computing resources. Other implementations of the example computing platform 102 are possible as well.

Further, in practice, the functional subsystems of the example computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

It should be understood that computing environment 100 is one example of a computing environment in which a data science model may be utilized, and that numerous other examples of computing environment are possible as well.

Implementing a computing platform that executes machine learning models like those described above to help make business decisions with respect to individuals and/or other entities within a population comprising one or more protected subpopulations may provide various advantages over conventional approaches for making business decisions, such as approaches in which one or more employees of an organization are tasked with reviewing some set of available information about an individual or other entity within a population and then making a business decision with respect to that individual. These advantages may include (i) reducing the time it takes to make business decisions, (ii) expanding the scope and depth of the information that can be practically evaluated when making business decisions, which leads to better-informed decisions, (iii) reaching decisions in a more objective, reliable, and repeatable way, and (iv) avoiding any bias that could otherwise be introduced (whether intentionally or subconsciously) by employees that are involved in the decision-making process, among other possibilities.

However, when an organization is utilizing machine learning models to help make business decisions with respect to individuals and/or other entities within a population comprising one or more protected subpopulations, this increases the difficulty of evaluating the organization's decision-making practices for improper bias (e.g., as part of a fair lending review under the ECOA) and then mitigating any such bias-particularly as the machine learning models being utilized become more complex. For instance, one example of such a machine learning model comprises a complex, trained object that is configured to (i) receive input data for some input set of feature variables, (ii) evaluate the input data, and (iii) based on the evaluation, output a prediction (e.g., a classification score and/or a classification prediction) that is then used make a decision regarding an individual or entity, such by comparing a classification score to a specified score threshold. There are some existing techniques available for evaluating whether this type of machine learning model exhibits improper bias that unfairly favors one subpopulation of individuals or other entities over others, but if improper bias is detected, it is very difficult to meaningfully evaluate which aspects of the machine learning model are causing that improper bias, and even more difficult to determine or implement an effective strategy for modifying the machine learning model so as to mitigate the improper bias.

Given these difficulties, organizations that wish to utilize machine learning models to help make business decisions were initially forced into a trial-and-error type of approach, where the process of deploying a machine learning model involved iteratively training and testing multiple different versions of the machine learning model (e.g., by using different hyperparameters) until the organization was able to find a version of the machine learning model that satisfied the applicable requirements regarding bias. However, this process of iteratively training and testing multiple different versions of a machine learning model that an organization wishes to deploy until the applicable requirements regarding bias are satisfied is time consuming, labor intensive, and costly. Further, mitigating the bias of the model by training a machine learning model with altered hyperparameters typically degrades the performance of the machine learning model.

To overcome these problems, efforts have recently been made to develop more intelligent and advanced technology for creating fairer machine learning models having reduced bias. For example, certain technological approaches for creating machine learning models having reduced bias were disclosed in each of (i) U.S. Pat. No. 12,002,258, which was filed on Jun. 3, 2020 by the present Applicant and is entitled “SYSTEM AND METHOD FOR MITIGATING BIAS IN CLASSIFICATION SCORES GENERATED BY MACHINE LEARNING MODELS,” and (ii) U.S. Pat. App. Pub. No. 2022/0414766, which was filed on Aug. 31, 2022 by the present Applicant and is entitled “COMPUTING SYSTEM AND METHOD FOR CREATING A DATA SCIENCE MODEL HAVING REDUCED BIAS,” each of which are assigned to the applicant of the present application and are incorporated herein by reference in their entirety.

However, the prior technology for creating fairer machine learning models having reduced bias still suffers from several problems. First, the prior technology either had difficulties reducing the bias of machine learning models beyond a certain practical limit, degraded the model performance by a greater extent than is desirable in order achieve reduced bias of the machine learning models, or both, which resulted in the creation of machine learning models that had a less-than-desirable tradeoff between model performance and model bias. There are several reasons for this, including that (i) at least some of the prior technology utilized random or Bayesian search rather than a true machine learning process (e.g., a model training process) as part of its process for determining how to modify the configuration of the machine learning model in a way that reduces bias while preserving acceptable performance, (ii) at least some of the prior technology attempted to reduce the bias by replacing input features of the machine learning model with transformations, but that prior technology was typically only capable of modifying a limited number of input features due to practical limitations and was also not necessarily suitable for categorical or discrete input features of the machine learning model, and (iii) at least some of the prior technology was focused on reducing the bias by adjusting the input feature variables of the machine learning model in a manner that affects the distribution of features globally as opposed to modifying the configuration of a machine learning model in a manner that impacts the bias locally (in space of features).

Second, the prior technology for creating fairer machine learning models tends to be slow, computationally expensive, and inefficient, particularly for certain types of machine learning models, which can make it difficult to utilize such prior technology in practice to create new machine learning models. There are several reasons for this, including that at least some of the prior technology utilized random or Bayesian search as part of its process for determining how to modify the configuration of the machine learning model in a way that reduces bias while preserving acceptable performance, which can be slow, computationally expensive, and inefficient in higher dimensions.

Third, at least some of the fairer machine learning models produced by the prior technology did not work well with model explainability techniques (or sometimes referred to as model interpretability techniques) that quantify the contributions of a machine learning model's input feature variables to the predictions output by the machine learning model, which made it difficult or impossible to explain the predictions output by the machine learning models produced by the prior technology.

Fourth, at least some of the fairer machine learning models produced by the prior technology required an identification of the particular subpopulation(s) to which an individual or entity belonged in order to produce and output a fairer prediction for that individual or entity, and in many scenarios, it is not permissible to rely on this type of subpopulation information when rendering a prediction related to an individual or entity.

The prior technology for creating fairer machine learning models having reduced bias may suffer from other problems as well.

To address these and other problems, disclosed herein is new technology for creating a fairer version of a machine learning model that (i) has an improved performance-bias tradeoff relative to machine learning models that are produced using prior technology for reducing bias and (ii) can still have its outputs explained using a model explainability technique, which may be utilized when there is a desire to create a new machine learning model that is governed by bias requirements (e.g., a machine learning model that is subject to a fair lending review under the ECOA) or otherwise gives rise to bias concerns.

In accordance with the disclosed technology, a computing platform may begin by training a machine learning model of a type that is capable of having its output explained by “additive explanations” for the machine learning model's input set of features, which are values quantifying the respective contributions of the machine learning model's input set of features to the machine learning model's output for an input record that sum up to a value that amounts to the difference between the machine learning model's output for the input record and the machine learning model's expected value (or sometimes referred to as the machine learning model's “baseline” or “reference” value). This function of training the machine learning model may be carried out by applying a machine learning process to a training dataset comprising a set of training records that each includes (i) values for a set of variables that are evaluated as possible input features for the machine learning model and (ii) a value for a target variable that is to be output by the machine learning model (e.g., a numerical variable, a classification label, etc.).

After training the machine learning model, the computing platform may define a perturbed version of the trained machine learning model (referred to herein as a “perturbed model” for simplicity) that serves as the foundation for the fairer version of the trained machine learning model. In accordance with the disclosed technology, the perturbed model includes additive explanations for the trained machine learning model's input set of features as input variables for the perturbed model, and the perturbed model may be configured to perturb such additive explanations by (i) multiplying each additive explanation by a respective “perturbation coefficient,” (ii) taking a summation of the coefficient-adjusted additive explanations, and then (iii) adjusting the summation by adding one additional perturbation coefficient (e.g., an offset constant). This portion of the perturbed model may be referred to herein as the “perturbed version of the additive explanations.” In turn, the computing platform may carry out functionality for determining a given set of values for the perturbation coefficients that are to be inserted into the perturbed model in order to produce the fairer version of the trained machine learning model.

The functionality for determining a given set of values for the perturbation coefficients may begin with the computing platform (i) determining, for each of at least a subset of the training records in the training dataset, a respective set of additive-explanation values for the training record, and (ii) representing the perturbed version of the additive explanations that is defined as part of the perturbed model in the form of a trainable object that is configured to receive a set of additive-explanation values for a training record as input and then produce and output a perturbed version of the additive explanations by applying a set of perturbation coefficients to the input set of additive-explanation values, where the set of perturbation coefficients are the trainable parameters of the trainable object. (As discussed below, instead of the additive explanations and perturbation coefficients themselves, it is also possible that the trainable object could work with dimensionality-reduced versions of the additive explanations and perturbation coefficients). In accordance with the present disclosure, the trainable object may generally comprise any type of trainable object that could be trained using a gradient descent process (e.g., stochastic gradient descent), and one possible example of such a trainable object may comprise a neural network that serves as a proxy for perturbed version of the additive explanations—such as a neural network implemented using a machine learning framework that provides for automatic differentiation (e.g., TensorFlow, PyTorch, etc.).

Next, the computing platform may produce different sets of candidate values for the perturbation coefficients by carrying out a training process for the trainable object (e.g., the neural network) using the respective sets of additive-explanation values determined for the training records and an objective function for the perturbed model that takes the form of a custom loss function comprising (i) an error term that quantifies the error of the perturbed model, (ii) a bias term that quantifies the bias of the perturbed model with respect to certain distinct subpopulations, and (iii) a bias coefficient that is applied to the bias term. During this training process, the perturbed version of the additive explanations that is defined as part of the perturbed model will be replaced by the trainable object (e.g., the neural network) for purposes of evaluating the objective function, and the training process may then involve multiple training “rounds” for the trainable object that are carried out using multiple different bias-coefficient values, where each such training round produces a respective set of candidate values for the perturbation coefficients corresponding to the respective bias-coefficient value that is used for the training round.

Lastly, the computing platform may utilize the different bias-coefficient values and their corresponding sets of candidate values for the perturbation coefficients to produce different instances of the perturbed model (where each such instance includes a respective set of candidate values for the perturbation coefficients), evaluate the performance and bias of the different instances of the perturbed model, and then based on that evaluation, determine the given set of values for the perturbation coefficients that are to be inserted into the perturbed model in order to produce the fairer version of the trained machine learning model, which may thereafter be deployed and executed.

The disclosed technology for creating a fairer version of a machine learning model may also involve other functionality, and is described in greater detail below.

Advantageously, the disclosed technology for creating a fairer (i.e., reduced-bias) version of a machine learning model provides a number of technological improvements over the existing technology for creating a machine learning model having reduced bias.

First, the disclosed technology produces machine learning models with reduced bias that have an improved performance-bias tradeoff relative to machine learning models with reduced bias that are produced using the existing technology. There are several reasons for this, including that (i) the disclosed technology determines the perturbation coefficients utilizing a machine-learning process that evaluates performance loss and bias, and (ii) the disclosed technology is capable of evaluating and determining perturbation coefficients for a large number of features, which increases the number of dimensions in which the machine learning model can be adjusted relative to certain of the existing technology.

Second, the disclosed technology is capable of producing machine learning models with reduced bias in a faster, less computationally expensive, and/or more efficient way than the existing technology for creating machine learning models having reduced bias.

Third, the machine learning models having reduced bias that are produced by the disclosed technology are explainable, in that the predictions output by the machine learning models can be explained using a model explanation technique that quantifies the contributions of a machine learning model's input feature variables to the predictions output by the machine learning model.

Fourth, the fairer versions of machine learning models that are produced by the disclosed technology are capable of achieving improved fairness without relying on a subpopulation value as part of its input, which means that such models can still be used in scenarios where it is not permissible to rely on subpopulation information when rendering predictions.

As described in further detail below, the disclosed technology for creating a fairer (i.e., reduce-bias) version of machine learning model may provide other technological improvements over the existing technology as well.

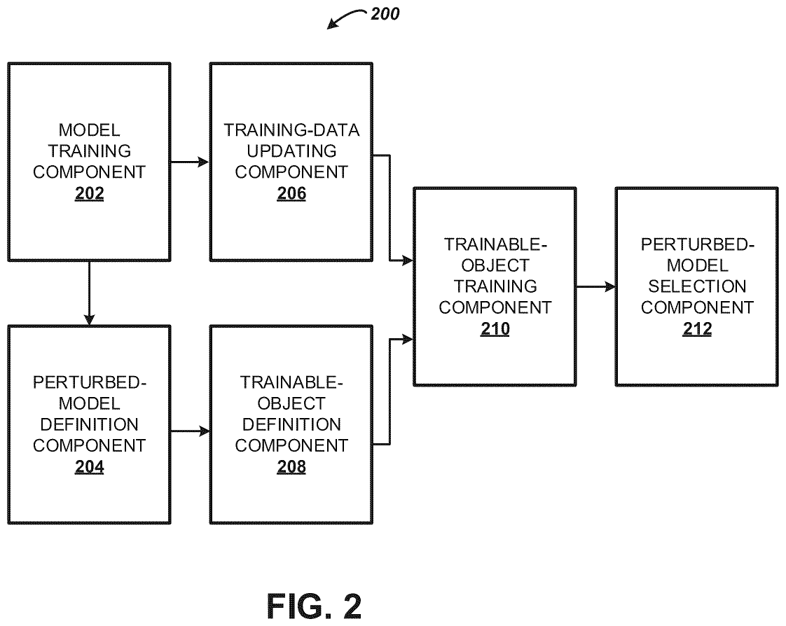

Turning now to FIG. 2, a block diagram of an example software-based pipeline 200 for creating a fairer version of a machine learning model (i.e., a machine learning model having reduced bias) in accordance with the present disclosure is shown. In practice, the example software-based pipeline 200 may comprise a set of functional components, each of which may be encoded in the form of program instructions that are executable by one or more processors of one or more computing platforms. For purposes of illustration, the example software-based pipeline 200 is described as being installed on and executed by the computing platform 102 of FIG. 1, but it should be understood that the example software-based pipeline 200 may be installed on and executed by any one or more computing platforms that are capable of performing the example operations of the example software-based pipeline 200, and in some cases, different components of the example software-based pipeline 200 may be executed by different computing platforms that communicate with one another via a network-based communication path. Further, it should be understood that the example software-based pipeline 200 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular embodiment.

As shown, the example software-based pipeline 200 may comprise a model training component 202, a perturbed-model definition component 204, a training-data updating component 206, a trainable-object definition component 208, a trainable-object training component 210, and a perturbed-model selection component 212, among other possible components that may be included in the example software-based pipeline 200. Each of these software components will now be described in further detail.

The example software-based pipeline 200 may begin with the model training component 202, which may function to train a machine learning model having an input comprising values for a set of feature variables (or “features” for simplicity) and an output comprising a prediction that could give rise to bias concerns—such as a prediction related to an individual or other entity from a population that includes one or more protected subpopulations (e.g., subpopulations defined based on gender, race, age, sexual orientation, religion, marital status, etc.). As one example to illustrate, the trained machine learning model's input set of features could comprise features related to an individual seeking to obtain a particular type of service from a financial institution (e.g., a financial service such as a loan, a credit card account, a bank account, or the like), and the trained machine learning model's output prediction could comprise a classification score and/or a classification label for the individual that the financial institution uses as a basis for deciding whether or not to extend the particular type of service to the individual. However, the input set of features and the prediction output by the machine learning model being trained could take many other forms as well—including but not limited to the possibility that the prediction could comprise a value for a continuous numeric variable rather than a classification score or a classification label.

In accordance with the present disclosure, the machine learning model that is trained by the model training component 202 may comprise any type of machine learning model that (i) has an input and output of the form described above and (ii) is capable of having its output explained by “additive explanations” for the machine learning model's input set of features—which as noted above are values quantifying the respective contributions of the machine learning model's input set of features to the machine learning model's output for an input record that sum up to a value that amounts to the difference between the machine learning model's output for the input record and the machine learning model's expected value (or sometimes referred to as the machine learning model's “baseline” or “reference” value). For instance, the machine learning model that is trained by the model training component 202 may comprise a tree-based model (e.g., an ensemble of decision trees that is trained using a Gradient Boosting or random forest technique), a neural-network-based model (e.g., a model based on one or more feed-forward, recurrent, and/or convolution neural networks), a support vector machines (SVM)-based model, a linear-regression-based model, and/or a k-Nearest Neighbor (kNN) model, among other possible types of a machine learning model that has an input and output of the form described above and is capable of having its output explained by additive explanations for the machine learning model's input set of features.

Further, in practice, the function of training the machine learning model may be carried out by applying a machine learning process for the desired model type to a training dataset comprising a set of training records that each contains (i) a respective set of values for the machine learning model's input set of feature variables, and (ii) a corresponding ground-truth value for a target variable of the machine learning model (which is sometimes referred to as a “target label”). In this respect, the training records may represent different individuals or other entities from a population that gives rise to bias concerns—such as a population that includes one or more protected subpopulations (e.g., subpopulations defined based on gender, race, age, sexual orientation, religion, marital status, etc.). However, it should be understood that the training dataset could take other forms as well. For instance, in some implementations, the training records in the training dataset could include values for additional feature variables that were utilized during training of the machine learning model but are not ultimately included in the input set of features that is defined for the trained machine learning model. Further, in some implementations, the corresponding ground-truth values may not be contained within the training records themselves but may instead be separate data entities that are associated with the training records in some manner (e.g., via a key value, a pointer, or the like). The training dataset may take other forms as well.

In accordance with the present disclosure, each training record in the training dataset may additionally contain or be associated with a respective “subpopulation” value for the respective individual or other entity represented by the training data record that indicates a particular subpopulation from a group of subpopulations (or perhaps multiple different subpopulations from multiple groups of subpopulations) to which that respective individual or other entity belongs, where the group(s) of subpopulations may be defined based on one or more attributes that give rise to bias concerns. For instance, if the machine learning model renders predictions of a given type for individuals from a population comprising two distinct subpopulations that give rise to bias concerns (e.g., male and female subpopulations), then each training record in the training dataset may also contain or be associated with a respective subpopulation value that indicates whether the respective individual represented by the training record belongs to either the first subpopulation (e.g., male) or the second subpopulation (e.g., female).

However, it should be understood that the subpopulation values that are contained within or otherwise associated with the training records are typically not utilized by the model training component 202 during the training of the machine learning model, nor does the trained machine learning model's input set of features depend on subpopulation values. Rather, such subpopulation values are included because they are utilized by other components of the disclosed software-based pipeline 200 in order to produce a fairer version of the trained machine learning model as described in further detail below (e.g., for purposes of determining the bias term of the objective function during training of the trainable object)—although as with the original version of the trained machine learning model, the fairer version of the trained machine learning model's input set of features will not depend on subpopulation values. In this respect, as with the trained machine learning model, the fairer version of the trained machine learning model that is produced will be a “demographically-blind” model.

As one illustrative example of the foregoing functionality, if the model training component 202 is tasked with training a machine learning model for predicting whether individuals from a population comprising multiple distinct subpopulations that give rise to bias concerns are qualified to receive a particular type of service offered by a financial institution (e.g., a financial service such as a loan, a credit card account, a bank account, or the like), the machine learning model's input may comprise an input set of feature variables that are predictive of whether or not the given individual is qualified to receive the particular type of service (e.g., feature variables that provide information related to credit score, credit history, loan history, work history, income, debt, assets, etc.), and the machine learning model's output may comprise a classification score that indicates a predicted likelihood that the given individual is qualified to receive the particular type of service and/or a predicted risk of extending the particular type of service to the given individual—where such classification score may be then compared against a threshold in order to make a classification prediction for the given individual of either a “qualified to receive service” or “not qualified to receive service.” And in this representative example, the training dataset for such a machine learning model may comprise a collection of training records that each contains or is associated with (i) a respective set of feature values for a respective individual that was previously evaluated by the financial institution for purposes of deciding whether to extend the particular type of service to the respective individual, (ii) a respective ground-truth value that indicates whether or not the respective individual was qualified to receive the particular type of service (e.g., a ground-truth value of either 1 if the respective individual was qualified to receive the particular type of service or 0 if the respective individual was not qualified to receive the particular type of service), and (iii) at least one respective subpopulation value that identifies at least one particular subpopulation to which the respective individual belongs (e.g., a value that indicates a particular gender, race, age, sexual orientation, religion, and/or marital status of the respective individual).

The machine learning model that is trained by the model training component 202 and the training dataset for the machine learning model may take many other forms as well.

Referring again to FIG. 2, the perturbed-model definition component 204 generally functions to define a perturbed version of the trained machine learning model, which as noted above may be referred to herein as the “perturbed model.” The perturbed model that is defined may take any of various forms.

At a high level, the perturbed model that is defined in accordance with the disclosed technology leverages the principle that additive explanations for the trained machine learning model's input set of features sum to a value that represents a difference between the trained machine learning model's output and the trained machine learning model's expected value, which can be represented as follows:

$$g ( x ) - E [ g ( X ) ] = {\sum }_{i = 1}^{n} {h}_{i} ( x ; g ) ,$$

where g(x) represents either the trained machine learning model (for a regressor type of model) or a regressor thereof (for a classification type of model), x represents a set of feature values for the trained machine learning model's input set of features, E[g(X)] represents the expected value of g(x), hᵢ(x) represents the additive explanation of a prediction output by the trained machine learning model g(x) for the i^{th} feature from the input set of features, n represents the number of features in the input set of features, and

$${\sum }_{i = 1}^{n} {h}_{i} ( x ; g )$$

represents a summation of the additive explanations across the input set of features. The foregoing principle is premised on an underlying assumption that an explanation of a constant function is zero and that additive explanations are centered.

The foregoing principle can then be rewritten as follows:

$$g ( x ) = {\sum }_{i = 1}^{n} {h}_{i} ( x ; g ) + E [ g ( X ) ] ,$$

which represents the trained machine learning model (for a regressor type of model) or a regressor thereof (for a classification type of model) in terms of a sum between (i) the summation of the additive explanations of a prediction output by the trained machine learning model g(x) for a set of feature values x across the trained machine learning model's input set of features and (ii) the expected value of the trained machine learning model (for a regressor type of model) or a regressor thereof (for a classification type of model). In other words, the foregoing represents that the output of the trained machine learning model (for a regressor type of model) or a regressor thereof (for a classification type of model) can be reproduced by (i) determining additive explanations that quantify the respective contributions of the trained machine learning model's input set of features to a prediction output by the trained machine learning model g(x) for the set of feature values x, (ii) summing the determined additive explanations across the input set of features, and (iii) adding the summation of the additive explanations together with the trained machine learning model's expected value.

Using this formulation of the trained machine learning model (for a regressor type of model) or a regressor thereof (for a classification type of model) as a starting point, a perturbed version of the of the trained machine learning model (for a regressor type of model) or a regressor thereof (for a classification type of model) may in turn be represented as:

$$\tilde{g} ( x ; α ) = {\sum }_{i = 1}^{n} ( 1 - {α}_{i} ) {h}_{i} ( x ; g ) + ( E [ g ( X ) ] - {α}_{0} ) ,$$

where \tilde{g}(x; α) represents the perturbed version of either the trained machine learning model (for a regressor type of model) or a regressor thereof (for a classification type of model), x represents a set of feature values for the trained machine learning model's input set of features, hᵢ(x; g) represents the additive explanation for the i^{th} feature from the input set of features (which quantifies the contribution of the i^{th} feature to the output of g(x) for the set of feature values x), n represents the number of features in the input set of features, E[g(X)] represents the expected value of g(x), (1−αᵢ) represents a perturbation of the additive explanation for the i^{th} feature that includes a respective perturbation coefficient αᵢ, and α₀ represents an additional perturbation coefficient that is subtracted from the expected value of g(x). In other words, in this formulation, each additive explanation is perturbed by multiplying it (1−αᵢ), and the summation of the coefficient-adjusted additive explanations is further perturbed by adding the expected value of g(x) and subtracting do.

Based on the principle that

$$g ( x ) = {\sum }_{i = 1}^{n} {h}_{i} ( x ; g ) + E [ g ( X ) ] ,$$

the foregoing formulation can be rewritten as follows:

$$\tilde{g} ( x ; α ) = g ( x ) - ( {\sum }_{i = 1}^{n} {α}_{i} {h}_{i} ( x ; g ) + {α}_{0} )$$

where \tilde{g}(x; α) represents the perturbed version of either the trained machine learning model (for a regressor type of model) or a regressor thereof (for a classification type of model), g(x) represents either the trained machine learning model (for a regressor type of model) or the regressor thereof (for a classification type of model), x represents a set of feature values for the trained machine learning model's input set of features, hᵢ(x; g) represents the additive explanation for the i^{th} feature from the input set of features (which quantifies the contribution of the i^{th} feature to the output of g(x) for the set of feature values x), n represents the number of features in the input set of features, at represents a respective perturbation coefficient that is applied to the additive explanation for the i^{th} feature,

$${\sum }_{i = 1}^{n} {α}_{i} {h}_{i} ( x ; g )$$

represents a summation of the coefficient-adjusted additive explanations across the input set of features, and do represents an additional perturbation coefficient that is added to the summation. In other words, in this formulation, each additive explanation is perturbed by multiplying it by a perturbation coefficient of αᵢ, and the summation of coefficient-adjusted additive explanations is further perturbed by adding the additional perturbation coefficient α₀.

In a scenario where the trained machine learning model is a regressor type of model, the foregoing formulation represents the perturbed model itself. On the other hand, in a scenario where the trained machine learning model is a classification type of model, the foregoing formulation may represent the perturbed version of a regressor for the classification type of model, and the perturbed model itself may be represented as:

$$\tilde{f} ( x ; α ) = σ ( \tilde{g} ( x ; α ) ) = σ ( g ( x ) - ( {\sum }_{i = 1}^{n} {α}_{i} {h}_{i} ( x ; g ) + {α}_{0} ) ) ,$$

where \tilde{f}(x; α) represents the perturbed version of the classification type of model, and σ represents a logistic function (or sometimes more broadly referred to as an activation function).

In each of the above formulations of the perturbed model, the portion of the perturbed model that includes the summation of the coefficient-adjusted additive explanations along with the additional perturbation coefficient that is added to the summation may be referred to herein as the “perturbed version of the additive explanations.”

The example formulations of the perturbed model shown above include a coefficient-adjusted version of an additive explanation for each feature in the trained machine learning model's input set of features. In some implementations, such a perturbed model may include non-zero perturbation coefficients for all of the additive explanations included in the perturbed model, in which case the functionality disclosed herein may be utilized to determine a respective non-zero perturbation coefficient for each additive explanation that is included in the perturbed model.

However, in other implementations, the perturbed model may include (i) non-zero perturbation coefficients for a first subset of the additive explanations included in the perturbed model and (ii) perturbation coefficients of zero for a second subset of the additive explanations included in the perturbed model, which effectively amounts to removing the second set of additive explanations from the perturbed model. And in practice, such a perturbed model that has perturbation coefficients of zero for a second subset of the additive explanations included in the perturbed model could also alternatively be represented as:

$$\tilde{g} ( x ; θ ) = g ( x ) - ( {\sum }_{l = 1}^{r} {θ}_{l} {h}_{{i}_{l}} ( x ; g ) + {α}_{0} ) ,$$

where hᵢ_{ₗ}(x; g), iₗ∈{i₁, i₂, . . . iᵣ} represents first subset of additive explanations that have non-zero perturbation coefficients, θₗ represents the non-zero perturbation coefficients of the additive explanations in the first subset, and r represents the number of additive explanations in the first subset.

In still other implementations, the perturbed model may include (i) non-zero perturbation coefficients having unknown values for a first subset of the additive explanations that are included in the perturbed model and (ii) non-zero perturbation coefficients having known, fixed values for a second subset of the additive explanations that are included in the perturbed model, in which case the functionality disclosed herein may be utilized to determine a respective non-zero perturbation coefficient for each additive explanation in the first subset while keeping the non-zero perturbation coefficient fixed for each additive explanation in the second subset.

The implementations where there are either perturbation coefficients of zero or perturbation coefficients having known, fixed non-zero values could also be combined such that there are three different subsets of additive explanations-one that has perturbation coefficients with unknown non-zero values, another that has perturbation coefficients of zero, and yet another that has perturbation coefficients with known, fixed non-zero values.

It will be appreciated that the perturbed version of the trained machine learning model shown above can be treated as a “linear” function in which the additive explanations for the trained machine learning model's input set of features are considered to be random variables that are arranged in a linear combination.

The perturbed model that is defined by the perturbed-model definition component 204 could take various other forms as well, including but not limited to the possibility that the perturbed model could include non-linear terms.

At this stage of the software-based pipeline 200, the values of the perturbation coefficients will typically be unknown, and the remaining components of the example software-based pipeline 200 may then carry out functionality for determining candidate values of the perturbation coefficients included in the perturbed model (e.g., the values of α₁, α₂, . . . , α₀) as well as do) that will serve to improve model fairness while still maintaining an acceptable level of model performance.

To facilitate this functionality, the perturbed-model definition component 204 may also define an objective function for use in determining candidate values of the perturbation coefficients. In accordance with the present disclosure, the defined objective function may take the form of a custom loss function that includes (i) an error term (which may also be referred to as a performance-loss term) that quantifies the error of the perturbed model, (ii) a bias term that quantifies the bias of the perturbed model with respect to certain distinct subpopulations (which may also be referred to as a fairness term), and (iii) a bias coefficient that is applied to the bias term (which may also be referred to as a fairness-penalization weight). Such an objective function may generally be represented as follows:

$$ℒ ( α ) = ℰ ( α ) + ω \cdot ℬ ( α ) ,$$

where [symbol] (α) represents the custom loss of the perturbed model for a given set of perturbation coefficients, ε(α) represents the error term of the objective function that quantifies the error of the perturbed model for the given set of perturbation coefficients, [symbol] (α) represents the bias term of the objective function that quantifies the bias of the perturbed model for the given set of perturbation coefficients, and ω represents the bias coefficient of the objective function. In this respect, the objective function may return the sum of the error term and the coefficient-adjusted bias term for a given set of perturbation coefficients. Each of the terms of the objective function may take any of various forms.

To begin, the error term of the objective function (i.e., the ε(α) term) may comprise any of various types of functions that quantify the error of the perturbed model, which may depend in part on the type of machine learning model at issue. For instance, if the machine learning model is a regressor type of model, then as one possible example, the error term may take the form of a function for determining a metric that is based on mean-squared loss of the perturbed model, such as an expected value of the cross-entropy loss of the perturbed model. This example of the error term may be represented as follows:

$$𝔼 [ {( \tilde{g} ( X ; α ) - Y )}^{2} ] \approx \frac{1}{k} {\sum }_{j = 1}^{k} {𝔼 ( \tilde{g} ( {x}^{( j )} ; α ) - {y}^{( j )} )}^{2} ,$$

where the function on the left represents the mean-squared loss at the population limit, the function on the right represents an empirical estimate of the mean-squared loss, \tilde{g}(x^{(j)}; α) represents the perturbed model, x^{(j)} represents a given input set of feature values for the j^{th} training record and has a dimensionality equal to the number of feature variables include in the trained machine learning model's input set of feature variables, α represents the perturbation coefficients, y^{(j)} represents a given ground-truth value of the machine learning model's target variable that corresponds to the given input set of feature values for the j^{th} training record, and k represents the total number of training records (although as discussed below, the training process will typically utilize less than the total number of training records to determine the error term during training).

On the other hand, if the machine learning model is a classification type of model, then as one possible example, the error term may take the form of a function for determining a metric that is based on cross-entropy loss of the perturbed model, such as an expected value of the cross-entropy loss of the perturbed model. This example of the error term may be represented as follows:

$$- 𝔼 [ CrossEntropy ( \tilde{f} ( x ; α ) , Y ) ] \approx - \frac{1}{k} {\sum }_{j = 1}^{k} CrossEntropy ( \tilde{f} ( {x}^{( j )} ; α ) , {y}^{( j )} ) ,$$

where the function on the left represents the expected cross-entropy at the population limit, the function on the right represents an empirical estimate of the expected cross-entropy, \tilde{f}(x; α) represents the perturbed model, x^{(j)} represents a given input set of feature values for the j^{th} training record and has a dimensionality equal to the number of feature variables include in the trained machine learning model's input set of feature variables, α represents the perturbation coefficients, y^{(j)} represents a given ground-truth value of the machine learning model's target variable that corresponds to the given input set of feature values for the j^{th} training record, and k represents the total number of training records (although as discussed below, the training process will typically utilize less than the total number of training records to determine the error term during training).

If the machine learning model is a classification type of model, then as another possible example, the error term may take the form of a function for determining a metric that is based on exponential loss, and such an error term may be represented as:

$$𝔼 [ {e}^{- \tilde{g} ( X ; α ) \cdot ( 2 \cdot Y - 1 )} ] \approx \frac{1}{k} {\sum }_{j = 1}^{k} {e}^{- \tilde{g} ( {x}^{( j )} ; α ) \cdot ( 2 \cdot {y}^{( j )} - 1 )} ,$$

where the function on the left represents the exponential loss at the population limit, the function on the right represents an empirical estimate of the exponential loss, labels y^{(j)} take values in {0,1}, and \tilde{g}(x^{(j)}; α) represents a regressor that is sometimes referred to as the raw probability score.

The error term of the objective function may take other forms as well, including but not limited to a function for determining a metric that is based on top-capture rate (e.g., a top-capture rate 50) or some other measure of a model's performance loss.

Further, the bias term of the objective function (i.e., the [symbol] (α) term) may comprise any of various types of functions that quantify the bias of the perturbed model with respect to distinct subpopulations, such as a group of distinct subpopulations that are defined based on either a single protected attribute or a combination of multiple protected attributes. In the discussion below, the example bias terms are at times described below in terms of quantifying the bias of the perturbed model with respect to two distinct subpopulations (e.g., a first subpopulation represented as A=0 and a second subpopulation represented as A=1), which could be defined based either on a single protected attribute or a combination of multiple protected attributes. For example, when quantifying the bias with respect to two distinct subpopulations, a first one of the distinct subpopulations could comprise individuals having a “majority” value for each of the one or more protected attributes used to define the subpopulations (e.g., male, white, etc.) and then a second one of the distinct subpopulations could comprise individuals having a “minority” value for any of the one or more protected attributes used to define the subpopulations (e.g., female, black, etc.). However, it should be understood that the bias term could alternatively quantify the bias of the perturbed model with respect to more than two distinct subpopulations.

As one possible example, the bias term of the objective function may take the form of a function for determining a generalization of a Cramer von Mises distance or a Wasserstein distance between (i) a first distribution of the predictions output by the perturbed model for a first distinct subpopulation and (ii) a second distribution of the predictions output by the perturbed model for a second distinct subpopulation. One example of the bias term may be represented as follows for a regressor type of model:

$${CM}_{p}^{p} ( \tilde{g} ( X ; α ) \vert A = 0 , \tilde{g} ( A ; α ) \vert A = 1 ; ρ ) = {\int }_{ℝ} {\vert {F}_{1} ( t ; α ) - {F}_{0} ( t ; α ) \vert}^{p} \cdot ρ ( t ) dt ,$$

where \tilde{g}(X; α) represents the perturbed model, α represents the perturbation coefficients, Fₖ(t; α) is the CDF of the sub-population distribution \tilde{g}(X; α)|A=k, and CMₚ represents the distance between the distributions of random variables. In this respect, CMₚ may be defined in the following way:

$${CM}_{p} ( {Z}_{1} , {Z}_{0} ; ρ ) = {( {\int }_{0}^{1} {\vert {F}_{{Z}_{0}} ( t ) - {F}_{{Z}_{1}} ( t ; α ) \vert}^{p} \cdot ρ ( t ) dt )}^{\frac{1}{p}} ,$$

which represents a generalization of a Cramer von Mises metric between distributions of random variables Z₀, Z₁. In this example, if p=1 and ρ=1, CM₁=W₁ where W₁ is the Wasserstein-1 distance, and if p=2 and ρ=1, CM₂ equals to Cramer-von Mises energy distance (and p=∞ corresponds to Kolmogorov-Smirnov distance), and ρ(t)≥0 is a weight function (which can be viewed as a probability density function for thresholds if one assumes that [symbol] ρ(t) dt=1).

On the other hand, if the perturbed model is a classification type of model of the form \tilde{f}(x; α)=σ(g(x; α)) where σ(t) is the logistic function, then the bias term may be adjusted as follows:

$${CM}_{p}^{p} ( \tilde{f} ( X ; α ) \vert A = 0 , \tilde{f} ( A ; α ) \vert A = 1 ; ρ ) = {\int }_{0}^{1} {\vert {F}_{1} ( t ; α ) - {F}_{0} ( t ; α ) \vert}^{p} \cdot ρ ( t ) dt ,$$

where Fₖ(t; α) is the CDF of the sub-population distribution \tilde{f}(X; α)|A=k, and ρ(t)≥0 is a weight function such that

$${\int }_{0}^{1} ρ ( t ) dt = 1 ,$$

where in practice we often set ρ(t)=1_{[0,1]}(t).

In this example where the perturbed model is a classification type of model of the form \tilde{f}(x; α)=σ(\tilde{g}(x; α)) where σ(t) is the logistic function, the bias term based on CMₚ may alternatively be represented as:

$${Bias}_{{CM}_{p}^{p}} ( \tilde{f} ( X ; α ) \vert A ) = {\int }_{0}^{1} {\vert {F}_{0} ( t ) - {F}_{1} ( t ) \vert}^{p} ρ ( t ) dt = {\int }_{0}^{1} {\vert 𝔼 [ {1}_{{Z}_{0} > t} ] - 𝔼 [ {1}_{{Z}_{1} > t} ] \vert}^{p} \cdot ρ ( t ) dt ,$$

where Zₖ~\tilde{f}(x; α)|A=k with the CDF FR, and ρ(t)≥0 is a given weight function which we assume satisfies

$${\int }_{0}^{1} ρ ( t ) dt = 1 , e . g . ρ ( t ) = {1}_{[ 0 , 1 ]} ( t ) .$$

In practice, it can be challenging from a computational perspective to determine the bias using a bias term such as the ones shown above, so in at least some implementations, the bias term of the objective function may alternatively take the form of an estimator of a target bias term. Such an estimator of a target bias term may take any of various forms.

For instance, a first example type of estimator of the bias term shown above for a classification type of model of the form \tilde{f}(x; α)=σ(g(x; α)) may be represented as:

$${\text{?}}_{{CM}_{p}^{p}} ( \tilde{f} ( X ; α ) \vert A ) = ( {\sum }_{i = 1}^{b} Δ {t}_{i} {\vert {\hat{R}}_{c} ( {t}_{i} ; α ; B ) \vert}^{p} \cdot ρ ( {t}_{i} ) ) \approx {Bias}_{{CM}_{p}^{p}} ( \tilde{f} ( X ; α ) \vert A ) ,$$

$$where$$

$${\hat{R}}_{c} ( t ; α , B ) := \frac{1}{{k}_{0}} {\sum }_{r = 1}^{{k}_{0}} {σ}_{c} ( \tilde{f} ( {x}^{( {j}_{r} )} ; α ) - t ) - \frac{1}{{k}_{1}} {\sum }_{r = 1}^{{k}_{1}} {σ}_{c} ( \tilde{f} ( {x}^{( {l}_{r} )} ; α ) - t ) \approx 𝔼 [ {1}_{{Z}_{0} > t} ] - 𝔼 [ {1}_{{Z}_{1} > t} ] = {F}_{1} ( t ) - {F}_{0} ( t ) = R ( t ) ,$$

and where c≥0 is the relaxation parameter and σ_{c}(t)=σ(c·t). With respect to this first example type of estimator, (i) features of subpopulations are sampled uniformly within each subpopulation to get the batch of samples

$${x}^{( {j}_{1} )} , … , {x}^{( {j}_{{k}_{0}} )}$$

for which a^{(j}^{₁}⁾=0, . . . ,

$${a}^{( {j}_{{k}_{0}} )} = 0$$

and similarly

$${x}^{( {l}_{1} )} , … , {x}^{( {l}_{{k}_{1}} )}$$

for which a^{(l}^{₁}⁾=1, . . . ,

$${a}^{( {l}_{{k}_{1}} )} = 1 ,$$

where such batches are represented as

$$B = \{ {z}_{0}^{( r )} = \tilde{f} ( {x}^{( {j}_{r} )} ; α ) ,$$

r∈{1, . . . , k₀}

$${z}_{1}^{r} = \tilde{f} ( {x}^{( {l}_{r} )} ; α ) , r ∈ \{ 1 , … , {k}_{1} \} \} ,$$

and (ii) the perturbed model \tilde{f}(x; α) is evaluated at each batch to obtain the samples of the probability scores within each subpopulation, and (iii) fixed thresholds t₀=0≤t₁≤ . . . ≤t_{b}=1 are selected that are typically uniformly distributed so that

$$Δ {t}_{i} = ( {t}_{i + 1} - {t}_{i} ) = \frac{1}{b} .$$

While the first example type of estimator is shown to use the right Rieman sums in the discretization of the integral in t, they can be replaced with the trapezoidal rule or any other integration rule. Further, it should be understood that if p=2, a different variation of the foregoing estimator may be utilized. Further yet, it is possible that the relaxation could take some other form. For example, the relaxation could alternatively take the form of either r_{c}(t)=r(c·t) where r(t)=1_{{0<t<1}}·t+1_{{t≥1}} or

$${r}_{c} ( t ) = σ ( c ( t - \frac{1}{\sqrt{c}} ) ) ,$$

each which may have the property that as c→∞, [symbol] [r_{c}(Z−t)]→ [symbol] (Z>t) even if the CDF F_{Z} has a jump at t. Other variations of the first example type of estimator are possible as well.

A second example type of estimator of the bias term shown above for a classification type of model of the form \tilde{f}(x; α)=σ(\tilde{g}(x; α)) may be represented as:

$${\text{?}}_{C {M}_{p}^{p}} ( \tilde{f} ( X ; α ) \vert A ) = ( \frac{1}{b} {\sum }_{i = 1}^{b} {\vert {\hat{R}}_{c} ( {t}_{i} ; α , B ) \vert}^{p} ) \approx B i a {s}_{{CM}_{p}} ( \tilde{f} ( X ; α ) \vert A ) .$$

With respect to this second example type of estimator, the thresholds t are sampled from the probability distribution given by the density function ρ(t) and the integration in t is replaced by sampling b≥0 thresholds {t₀, t₁, . . . , t_{b}} from the distribution given by the density ρ(t).

A third example type of estimator of the bias term shown above for a classification type of model of the form \tilde{f}(x; α)=σ(\tilde{g}(x; α)) for the case where p=2 may be represented as:

$${\text{?}}_{{CM}_{2}^{2}} ( \tilde{f} ( X ; α ) \vert A ) = \frac{1}{2 \cdot k} ( {\sum }_{r = 1}^{k} \vert {z}_{0}^{( r )} - {z}_{1}^{( r )} \vert + {\sum }_{r = 1}^{k} \vert {\overline{z}}_{0}^{( r )} - {\overline{z}}_{1}^{( r )} \vert - {\sum }_{r = 1}^{k} \vert {z}_{0}^{( r )} - {\overline{z}}_{0}^{( r )} \vert - {\sum }_{r = 1}^{k} \vert {z}_{1}^{( r )} - {\overline{z}}_{1}^{( r )} \vert ) .$$

With respect to this third example type of estimator, (i) features of subpopulations may be sampled (e.g., uniformly at random) within each subpopulation to get the batch of samples x^{(j}^{₁}⁾, . . . , x^{(ij}^{ₖ}⁾ for which a^{(j}^{₁}⁾=0, . . . , a^{(j}^{ₖ}⁾=0 and similarly x^{(l}^{₁}⁾, . . . , x^{(l}^{ₖ}⁾ for which a^{(l}^{₁}⁾=1, . . . , a^{(l}^{ₖ}⁾=1, where such batches are represented as

$$B = : \{ {z}_{0}^{( r )} = \tilde{f} ( {x}^{( {j}_{r} )} ; α ) ,$$

r∈{1, . . . , k} and z₁^{(r)}=\tilde{f}(x^{(l}^{ᵣ}⁾; α), r∈{1, . . . , k}} and pairs

$$( {z}_{0}^{( r )} , {z}_{1}^{( r )} )$$

are samples from the distribution P_{Z}_{₀}⊗P_{Z}_{₁}, (ii) the model \tilde{f}(x; α) may be evaluated at each batch to obtain the samples of the probability scores within each subpopulation, and (iii) the sampling procedure is repeated using batches that are represented as

$$\overline{B} = : \{ {\overline{z}}_{0}^{( r )} = \tilde{f} ( {x}^{( {\overline{j}}_{r} )} ; α ) ,$$

r∈{1, . . . , k} and

$${\overline{z}}_{1}^{( r )} = \tilde{f} ( {x}^{( {\overline{l}}_{r} )} ; α ) ,$$

r∈{1, . . . , k}}. In this respect, the third example type of estimator may avoid the integration over thresholds all together following the connection between the energy distance and Cramer von Mises criterion.

While the foregoing example types of estimators have been described with reference to a perturbed model that is of a classification type, it should be understood that similar types of estimators may be utilized for a perturbed model of a regressor type having the form \tilde{g}(X; α), where the distance is computed for the distribution of the regressor \tilde{g}(X; α). However, the first example type of estimator (which involves numerical integration over t) may further account for the fact that the support of the regressor could be infinite by utilizing an approach to avoid integration over the infinite interval of thresholds in practice, such as by using the density

$$ρ ( t ; α ) = \frac{1}{b - a} {1}_{( a , b )} ( t )$$

where the interval (a, b) can be picked using the quantiles of the empirical distribution of the distribution

$$\tilde{g} ( X ; α ) , e . g . a = {F}_{\tilde{g}}^{[ - 1 ]} ( 0.01 ) and b = {F}_{\tilde{g}}^{[ - 1 ]} ( 0.01 ) .$$

Further, for the second and third example types of estimator, sampling may be directly from \tilde{g}(X; α).

The estimator of a target bias term based on a generalization of a Cramer von Mises distance or a Wasserstein distance may take various other forms as well.

The bias term of the objective function may take other forms as well, including but not limited to a function for determining a metric that is based on adverse impact ratio (AIR) (e.g., a LOG-AIR or AIR50 metric), Kolmogorov-Smirnov, or some other measure of a model's bias.

Further yet, the bias coefficient of the objective function (i.e., the ω coefficient) may comprise a numeric value selected from a defined set of candidate bias-coefficient values that is applied to the bias term of the objective function in order adjust the weight of the bias term relative to the error term. This defined set of candidate bias-coefficient values may be represented as:

$$ω ∈ [ {ω}_{1} , {ω}_{2} , … , {ω}_{l} ] ,$$

wherein ω represents the bias-coefficient value and l represents the number of bias-coefficient values included in the defined set of candidate bias-coefficient values.

In this respect, the defined set of candidate bias-coefficient values from which the bias coefficient is selected may take any of various forms, and as some possible examples, the defined set of candidate bias-coefficient values may comprise (i) a set of discrete values ranging from 0 to 1 or (ii) a set of discrete values ranging from a minimum value that corresponds to 0% of the error term and a maximum value that corresponds to 100% of the error term, among other possibilities. The bias coefficient of the objective function may take other forms as well.

The objective function that is defined by the perturbed-model definition component 204 could take various other forms as well.

The defined objective function can then be utilized to determine candidate values of the perturbation coefficients, which may generally involve (i) inserting a given value for the bias coefficient into the objective function and then (ii) determining which values of the perturbation coefficients minimize the objective function. (As used herein, the term “minimize” does not necessary mean that a set of values for the perturbation coefficients achieve a global or absolute minimum of the objective function, but rather that the set of values for the perturbation coefficients achieve a local or approximate minimum of the objective function during a training process). However, given the complexity of the objective function—and in particular the bias term—the function of determining which values of the perturbation coefficients minimize the objective function can only practically be performed by a computer employing a machine-learning training process. The remaining components of the example software-based pipeline 200 are tasked with particular functionality for carrying out such a machine-learning training process in order to determine candidate values of the perturbation coefficients across different bias-coefficient values.

The functionality of the perturbed-model definition component 204 may take other forms as well. Further, in practice, the functions of defining the perturbed model and/or defining the objective function may be carried out based on configuration information for the perturbed model and/or the objective function that is provided as input to the perturbed-model definition component 204, among other possibilities. For instance, the perturbed-model definition component 204 may function to receive configuration information for the perturbed model and/or the objective function (e.g., configuration information that is specified by a user and/or contained within a definition file that is created by some other software component) and then define (e.g., initialize and/or instantiate) the perturbed model and/or the objective function based on that received configuration information.

Referring again to FIG. 2, the training-data updating component 206 may function to update the training dataset that was utilized to train the machine learning model to include, for each of at least a subset of the training records in the training dataset, a respective set of additive-explanation values that quantify the respective contributions of the trained machine learning model's input set of features to the prediction that is output by the trained machine learning model (e.g., the predicted value of the target variable) for the training record. This functionality for updating the training dataset to include respective sets of additive-explanation values for at least a subset of the training records may take any of various forms.

As one possibility, the functionality for updating the training dataset to include a set of additive-explanation values for a given training record may involve (i) utilizing a model explainability technique to determine a given set of additive-explanation values that quantify the respective contributions of the trained machine learning model's input set of features to the trained machine learning model's output for the given training record, and (ii) adding the given set of additive-explanation values to the given training record or otherwise associating the given set of additive-explanation values with the given training record in some manner (by including the given set of additive-explanation values in a separate data record that is associated with the given training record via a key value, a pointer, or the like). The training-data updating component 206 may carry out this functionality for each of at least a subset of the training records in the training dataset.

The model explainability technique that is utilized by the training-data updating component 206 to determine the respective sets of additive-explanation values for the training records may comprise any type of model explainability technique that is capable of producing additive explanations, which as noted above are values quantifying the respective contributions of the trained machine learning model's input set of features to the machine learning model's output for an input record that sum up to a value that amounts to the difference between the machine learning model's output for the input record and the machine learning model's expected value. One possible type of such a model explainability technique may comprise a game-theoretic explainability technique for determining or approximating marginal or conditional game values that are additive, such as Shapley values, Owen values, or Banzhaf-Owen values, and some representative examples of such a game-theoretic explainability technique include (i) the model-agnostic Shapley Additive Explanation (SHAP) technique, (ii) the family of model-specific variants of SHAP, such as TreeSHAP (e.g., path-dependent or interventional TreeSHAP), KernelSHAP, or LinearSHAP, and (iii) the techniques described in the paper entitled “On Marginal Feature Attributions of Tree-Based Models” by Filom et al., which was published in Foundations of Science Data in December 2024, is available at https://www.aimsciences.org/article/doi/10.3934/fods.2024021, and is incorporated herein by reference. However, other possible types of model explainability techniques could be utilized to determine the respective sets of additive-explanation values for the training records as well, including but not limited to a Local Interpretable Model-agnostic Explanations (LIME) technique or a plot-based explanation technique (e.g., Partial Dependence Plots (PDP), Individual Conditional Expectation (ICE) plots, Accumulated Local Effects (ALE), etc.), among others.

As a result of carrying out this functionality, each of at least the subset of the training records in the training dataset (which as noted above may for an individual or other entity from a subpopulation that gives rise to bias concerns) may contain or be associated with (i) a respective set of feature values for the trained machine learning model's input set of features, (ii) a respective ground-truth value for the trained machine learning model's target variable, (iii) a respective subpopulation value that indicates at least one particular subpopulation to which the respective individual or other entity belongs, and (iv) a respective set of additive-explanation values that quantify the respective contributions of the trained machine learning model's input set of features to the prediction that is output by the trained machine learning model (e.g., the predicted value of the target variable) for the respective set of feature values.

To illustrate with a specific example, for each of at least a subset of training records in the training dataset, the training-data updating component 206 may determine a respective set of n additive-explanation values corresponding to the n features that are included in the input set of features. These respective sets of additive-explanation values may be represented as

$$( {h}_{1}^{( k )} , {h}_{2}^{( k )} , … , {h}_{n}^{( k )} ) ,$$

where

$${h}_{1}^{( k )}$$

represents a first additive-explanation value quantifying the contribution of the trained machine learning model's first feature for the k^{th} training record in the training dataset,

$${h}_{2}^{( k )}$$

represents a second additive-explanation value quantifying the contribution of the trained machine learning model's second feature for the k^{th} training record in the training dataset, and so on until

$${h}_{n}^{( k )}$$

represents the n^{th} additive-explanation value quantifying the contribution of the trained machine learning model's n^{th} feature for the k^{th} training record in the training dataset.

The functionality for updating the training dataset to include or be associated with respective sets of additive-explanation values for at least a subset of training records may take other forms as well.

In at least some implementations, in addition to updating at least the subset of training records to include respective sets of additive-explanation values, the training-data updating component 206 may also function to update a set of “test records”—which are data records containing the same types of data contained within the training records (e.g., feature values, a ground-truth value, and a subpopulation value) that are not utilized to train the machine learning model but can be utilized to test the machine learning model after it has been trained—to include respective sets of additive-explanation values. In this respect, updating such a set of test records to include respective sets of additive-explanation values may enable the test records to be utilized in addition to (or perhaps in alternative) to the training records when performing any of the other functions described below that make use of the training records—such as the functions of training the trainable object, evaluating the performance and bias of the different instances of the perturbed model that are produced, and/or determining explanations for the predictions that are output by the fairer version of the trained machine learning model.

The functionality that is carried out by the training-data updating component 206 may take other forms as well, including but not limited to the possibility that the training-data updating component 206 may create a new set of training records that contain the respective sets of additive-explanation values rather than updating the training records that were utilized to train the machine learning model.

Turning next to the trainable-object definition component 208 of the software-based pipeline 200, that component may function to represent the perturbed version of the additive explanations that is defined as part of the perturbed model in the form of a trainable object that includes the perturbation coefficients (i.e., the at coefficients as well as the additional do coefficient) as the trainable parameters of the trainable object, where that trainable object can thereafter be utilized to determine candidate values for the perturbation coefficients. In line with the discussion above, such a trainable object may generally comprise any type of trainable object that could be trained using a gradient descent process (e.g., stochastic gradient descent).

For instance, as one possibility, the trainable object may comprise a neural network that serves as a proxy for the perturbed version of the additive explanations, such as a linear neural network having (i) an input comprising a set of additive-explanation values for a training record and (ii) an output comprising a summation of coefficient-adjusted additive-explanation values that is further adjusted by adding an additional perturbation coefficient. For instance, one example of such a neural network that serves as a proxy for a perturbed version of the additive explanations having a form of

$${\sum }_{i = 1}^{n} {α}_{i} {h}_{i} ( x ; g ) + {α}_{0}$$

may be represented as follows:

$$𝒩 ( h ; α ) = ( input ) ( {h}_{1} , {h}_{2} , … , {h}_{n} ) \to ( output ) {\sum }_{i = 1}^{n} {α}_{i} {h}_{i} + {α}_{0} ,$$

where [symbol] (h; α) represents the neural network, h=(h₁, h₂, . . . , hₙ) represents a set of additive-explanation values for a given training record, hᵢ represents the additive explanation for the i^{th} feature in the trained machine learning model's input set of features, αᵢ represents the respective perturbation coefficient that is to be applied to additive explanation for the i^{th} feature, and n represents the number of features in the trained machine learning model's input set of features.

In this respect, it will be appreciated that the perturbation coefficients of the perturbed model are defined to be the trainable parameters (e.g., the weights and biases) of the neural network, which allows the perturbation coefficients to be determined during training of the neural network. Additionally, it will also be appreciated that the input of the neural network defined by the trainable-object definition component 208 comprises the additive-explanation values output for the trained machine learning model's input set of features rather than the feature values for the input set of feature variables, which allows the neural network to be trained using the respective sets of additive-explanation values that are determined by the training-data updating component 206.

The trainable-object definition component 208 may define a neural network that takes other forms as well.

Further, in at least some implementations, the neural network representing the perturbed version of the additive explanations may be implemented using a machine learning framework that provides for automatic differentiation, examples of which include the TensorFlow framework that was developed by the Google Brain Team and the PyTorch platform framework that was developed by Meta AI, such that the function of training the neural network and thereby determining candidate values of the perturbation coefficients can be facilitated by the machine learning framework.

The trainable-object definition component 208 may represent the perturbed version of the additive explanations in the form of some other type of trainable object as well. Further, in practice, the function of defining the trainable object may be carried out based on configuration information for the trainable object that is provided as input to the trainable-object definition component 208, among other possibilities. For instance, the trainable-object definition component 208 may function to receive configuration information for the trainable object (e.g., configuration information that is specified by a user and/or contained within a definition file that is created by some other software component) and then define (e.g., initialize and/or instantiate) the trainable object based on that received configuration information.

After the additive-explanation values for the training records have been determined and the perturbed version of the additive explanations has been represented in the form of the trainable object, the trainable-object training component 210 may then determine candidate values for the perturbation coefficients that are to be included in the perturbed model by carrying out a training process for the trainable object (e.g., the neural network) using the objective function for the perturbed model and the respective sets of additive-explanation values determined for the training records. This functionality may take any of various forms.

To begin, the trainable-object training component 210 may update the objective function for the perturbed model to replace the perturbed version of the additive explanations with the trainable object that is defined by the trainable-object definition component 208—which includes the perturbation coefficients as the trainable parameters of the trainable object (e.g., the weights and biases of the neural network) that are to be determined during training.

To illustrate with a first example where the perturbed model is of a regressor type having a form of

$$\tilde{g} ( x ; α ) = g ( x ) - ( {\sum }_{i = 1}^{n} {α}_{i} {h}_{i} ( x ; g ) + {α}_{0} )$$

and the objective function for the perturbed model has the following form:

$$\frac{1}{k} {\sum }_{j = 1}^{k} {𝔼 ( g ( {x}^{( j )} ; α ) - {y}^{( j )} )}^{2} + ω \cdot {\text{?}}_{{CM}_{p}^{p}} ( \tilde{g} ( X ; α ) \vert A ) ,$$

then an updated objective function may be represented as:

$$\frac{1}{k} {\sum }_{j = 1}^{k} {𝔼 ( [ g ( {x}^{( j )} ) - \text{?} ( {h}^{( j )} ; α ) ] - {y}^{( i )} )}^{2} + ω \cdot {\text{?}}_{{CM}_{p}^{p}} ( [ g ( X ) - \text{?} ( {h}_{1} ( X ; g ) , … {h}_{n} ( X ; g ) ; α ) ] \vert A ) ,$$

where [symbol] (h^{(j)}; α) and [symbol] (h₁ (X; g), . . . hₙ(X; g); α) represent a neural network of the form described above that has been inserted in place of the perturbed version of the additive explanations and (h^{(j)}; g) corresponds to a vector of additive-explanation values for a training record x^{(j)} of the trained machine learning model g(x) that can be represented as h₁(x^{(j)}; g), h₂(x^{(j)}; g), . . . hₙ(x^{(j)}; g).

To illustrate with a second example where the perturbed model is of a classification type having a form of

$$\tilde{f} ( x ; α ) = σ ( g ( x ) - ( {\sum }_{i = 1}^{n} {α}_{i} {h}_{i} ( x ; g ) + {α}_{0} ) )$$

and the objective function for the perturbed model has the following form:

$$- \frac{1}{k} {\sum }_{j = 1}^{k} CrossEntropy ( \tilde{f} ( {x}^{( j )} ; α ) , {y}^{( j )} ) + ω \cdot {\text{?}}_{{CM}_{p}^{p}} ( \tilde{f} ( X ; α ) \vert A ) ,$$

then the updated objective function may be represented as:

$$ℒ ( α ) = - \frac{1}{k} {\sum }_{j = 1}^{k} CrossEntropy ( σ ( g ( {x}^{( j )} ) - \text{?} ( {h}^{( j )} ; α ) ) , {y}^{( j )} ) ++ ω \cdot {\text{?}}_{{CM}_{p}^{p}} ( σ ( g ( X ) - \text{?} ( {h}_{1} ( X ; g ) , … {h}_{n} ( X ; g ) ; α ) ) \vert A ) ,$$

where [symbol] ((h^{(j)}; g); α) and [symbol] (h₁(X; g), . . . hₙ(X; g); α) represent a neural network of the form described above that has been inserted in place of the perturbed version of the additive explanations.

Other examples of updated objective functions that include the trainable object in place of the perturbed version of the additive explanations are possible as well.

The trainable-object training component 210 may then utilize this updated objective function as the starting point for the training of the trainable object.

Given that the objective function for the perturbed model includes a bias coefficient that may have any of multiple different bias-coefficient values from the defined set of candidate bias-coefficient values, the trainable-object training component 210 may then engage in multiple different “rounds” of training the trainable object for the multiple different bias-coefficient values in the defined set of bias-coefficient values—which may result in the trainable-object training component 210 determining multiple different sets of candidate values for the perturbation coefficients corresponding to the different candidate bias-coefficient values. For example, the trainable-object training component 210 may determine a first set of candidate perturbation coefficient for a first bias-coefficient value during a first training round, a second set of candidate perturbation coefficient for a second bias-coefficient value during a second training round, and so on for each of the other bias-coefficient values included in the defined set of candidate bias-coefficient values.

During each such training round, the functionality that is carried out by the trainable-object training component 210 may involve (i) defining a respective instance of the objective function to utilize for the training round, which may be referred to herein as the “round-specific instance of the objective function,” and (ii) determining a respective set of candidate values for the perturbation coefficients that minimizes the round-specific instance of the objective function, which may be referred to herein as the “round-specific set of candidate values for the perturbation coefficients.” (As noted above, the term “minimizes” as used herein does not necessary mean that the determined set of candidate values for the perturbation coefficients achieves a global or absolute minimum of the round-specific instance of the objective function, but rather that it achieves a local or approximate minimum of the round-specific instance of the objective function for a certain training round). Each of these functions may take any of various forms.

For instance, the function of defining a round-specific instance of the objective function to utilize for a given training round may begin with the trainable-object training component 210 selecting a bias-coefficient value from the defined set of bias-coefficient values and then creating an instance of the objective function for the perturbed model that includes the selected bias-coefficient value for the bias coefficient. To illustrate with an example, if the selected bias-coefficient value for the given training round is ω₁, the round-specific instance of the objective function that is defined by the trainable-object training component 210 for the given training round may be represented as:

$$ℒ ( α ) = ℰ ( α ) + {ω}_{1} \cdot ℬ ( α ) ,$$

where the ε(α) error term and the [symbol] (α) bias term could each have any of the various forms discussed above.

Further, the function of defining the round-specific instance of the objective function to utilize for the given training round may additionally involve implementing the round-specific instance of the objective function within a machine learning framework that provides for automatic differentiation, examples of which may be the TensorFlow and PyTorch frameworks, such that evaluation of the objective function can be facilitated by the machine learning framework. For instance, the round-specific instance of the objective function may be implemented in the form of a method that combines Tensorflow objects (e.g., instances of classes) that are subject to backpropagation in order to output a TensorFlow object that can be differentiated by the automatic differentiation, such as a method that combines a first TensorFlow object that is subject to backpropagation for the error term and a second TensorFlow object that is subject to backpropagation for the bias term, and the TensorFlow framework may then transform the method into compiled C or C++ code that, when executed, carries out at least some of the functions involved in evaluating the objective function.

The function of defining the round-specific instance of the objective function to utilize for the given training round may take other forms as well.

In turn, the function of determining the round-specific set of candidate values for the perturbation coefficients that minimizes the round-specific instance of the objective function for the given training round may involve carrying out an optimization process for determining the round-specific set of candidate values for the perturbation coefficients (which as noted above are included as the trainable parameters of the trainable object) that minimizes the round-specific instance of the objective function. This optimization process may take any of various forms.

For instance, as one possible implementation, the trainable-object training component 210 may carry out a gradient descent process that utilizes backpropagation to calculate the derivatives (i.e., the gradients) of the objective function in order to determine the respective set of candidate values for the perturbation coefficients that minimizes the respective instance of the objective function across the respective sample batch of training records. One possible example of such a gradient descent process is stochastic gradient descent, but other variants of gradient descent that are capable of utilizing backpropagation to calculate the derivatives of the objective function are also possible.

In such an implementation, the gradient descent process may begin by initializing a first set of values to evaluate for the perturbation coefficients, inserting the first set of values into the round-specific instance of the objective function (and in particular the trainable object), and utilizing backpropagation to compute the derivative of the round-specific instance of the objective function with the first set of values inserted—which may collectively be considered the first iteration of the gradient descent process for the given training round. Thereafter, the gradient descent process may comprise multiple subsequent iterations for evaluating multiple other sets of values for the perturbation coefficients until a stopping condition is met, where each subsequent iteration involves (i) utilizing the computed derivative of the round-specific instance of the objective function having the prior set of values for the perturbation coefficients as a basis for determining a next set of values to evaluate for the perturbation coefficients, (ii) inserting the next set of values into the round-specific instance of the objective function (and in particular the trainable object), and (iii) utilizing backpropagation to compute the derivative of the round-specific instance of the objective function with the next set of values inserted. The current set of values for the perturbation coefficients at the time that the stopping condition is met may then be identified as the round-specific set of candidate values for the perturbation coefficients that minimizes the round-specific instance of the objective function for the given training round.

During each given iteration of the example gradient descent process described above, backpropagation may be utilized to compute the derivative of the round-specific instance of the objective function with respect to either (i) a single training record that is randomly selected from the training dataset, (ii) a subset of the training records that are randomly selected from the training dataset (e.g., 100 training records), or (iii) the entire set of training records from the training dataset, among other possibilities. And in line with the discussion above, each such training record may contain or be associated with (i) a respective set of feature values for the input set of features, which is provided as input to the trained machine learning model included within both the error term and the bias term of the objective function during the derivative computation, (ii) a respective set of additive-explanation values for the input set of features, which is provided as input to the trainable object included within both the error term and the bias term of the objective function during the derivative computation, (iii) a ground-truth value for the machine learning model's target variable, which is provided as input to the error term of the objective function during the derivative computation, and (iv) a subpopulation value that indicates the particular subpopulation to which the represented individual or other entity belongs, which is provided as input to the bias term of the objective function during the derivative computation. However, the training record(s) that are utilized during each given iteration of the example gradient descent process may take various other forms as well, including but not limited to the possibility that the training records could additionally include prediction values output by the trained machine learning model for the training records that are pre-determined prior to carrying out example gradient descent process (e.g., by evaluating the training records with the trained machine learning model), in which case such pre-computed prediction values could be used where the trained machine learning model appears within the error and bias terms of the objective function.

Further, during each given iteration of the example gradient descent process described above (after the first iteration), the function of utilizing the computed derivative for the prior set of values of the perturbation coefficients as a basis for determining the next set of values to evaluate for the perturbation coefficients may take any of various forms, and in at least some examples, the next set of values may be determined utilizing the following function:

$${α}^{( t )} = {α}^{( t - 1 )} - ϵ \cdot {∇}_{a} ℒ ( {α}^{( t - 1 )} ) ,$$

where α^{(t)} represents the next set of values for the perturbation coefficients, α^{(t-1)} represents the prior set of values for the perturbation coefficients, ∇_{α} [symbol] (α^{(t-1)}) represents the computed derivative (i.e., the gradient) of the round-specific instance of the objective function having the prior set of values for the perturbation coefficients, and ϵ represents a learning-rate value that controls how much the perturbation coefficients are adjusted from iteration-to-iteration of the example stochastic gradient descent process.

Further yet, in the example gradient descent process described above, the stopping condition may take any of various forms, examples of which may include a stopping condition related to the output of the round-specific instance of the objective function (e.g., a minimum threshold for the output value of the round-specific instance of the objective function and/or a convergence condition comprising a minimum threshold extent of change of the output value of the round-specific instance of the objective function from one iteration of the gradient descent process to another), the perturbation coefficient values, the number of iterations of the gradient descent process (e.g., 50 iterations), and/or some combination thereof, among other possibilities.

The optimization process for determining the round-specific set of candidate values for the perturbation coefficients that minimizes the round-specific instance of the objective function for the given training round may take various other forms as well, including but not limited to other forms of gradient descent.

Moreover, in an embodiment where the round-specific instance of the objective function for the given training round is encoded in the form of a combination of objects within a machine learning framework that provides for automatic differentiation such as TensorFlow or PyTorch, then the machine learning framework may be utilized to facilitate the optimization process. For example, if the round-specific instance of the objective function for the given training round is encoded in the form of a method comprising a combination of TensorFlow objects that are subject to backpropagation, then the TensorFlow framework may be utilized to facilitate the optimization process. In such an example, the TensorFlow framework may function to transform the method representing the round-specific instance of the objective function into compiled C or C++ code that is then executed when performing certain functions during the evaluation of the round-specific instance of the objective function, such as when performing the computationally-intensive function of computing the derivative of the round-specific instance of the objective function during each iteration of the gradient descent process. Additionally, in such an example, the TensorFlow framework (which as noted provides for automatic differentiation) may also function to implement and compile the gradient of the objective function in C or C++ code. Advantageously, this approach of implementing the round-specific instance of the objective function for each given training round within a platform that provides for automatic differentiation may significantly speed up the optimization process for the given training round relative to an embodiment where the round-specific instance of the objective function is implemented in the form of Python code or the like.

The function of determining the round-specific set of candidate values for the perturbation coefficients that minimizes the round-specific instance of the objective function for the given training round may take other forms as well.

As noted above, the trainable-object training component 210 may carry out a respective round of the foregoing training functionality for each respective bias-coefficient value in the defined set of bias-coefficient values, which may result in the trainable-object training component 210 determining multiple different sets of candidate values for the perturbation coefficients corresponding to the different candidate bias-coefficient values (e.g., a first set of candidate perturbation coefficient for a first bias-coefficient value, a second set of candidate perturbation coefficient for a second bias-coefficient value, etc.). In this respect, increasing the number of bias-coefficient values in the defined set of bias-coefficient values (and thus the number of training rounds) will increase the number of different sets of candidate values for the perturbation coefficients that are produced by the trainable-object training component 210—and thereby increase the number of different instances of the perturbed model that can be evaluated as a fairer version of the machine learning model.

The functionality of the trainable-object training component 210 may take various other forms as well.

The different sets of candidate values for the perturbation coefficients corresponding to the different candidate bias-coefficient values may then be passed from the trainable-object training component 210 to the perturbed-model selection component 212, which may function to select a given instance of the perturbed model having one given set of perturbation coefficients. This functionality may take any of various forms.

As one possibility, the function of selecting the given instance of the perturbed model having the one given set of perturbation coefficients may begin with the perturbed-model selection component 212 performing the following functionality for each respective set of candidate values for the perturbation coefficients determined by the trainable-object training component 210 (i.e., each candidate bias-coefficient value's corresponding set of candidate values for the perturbation coefficients): (i) creating a respective instance of the perturbed model that includes the respective set of candidate values for the perturbation coefficients (e.g., by inserting the respective set of candidate values for the perturbation coefficients into the perturbed model) and then (ii) determining a respective pair of performance and bias values for the respective instance of the perturbed model.

The performance and bias values that are determined for each respective instance of the perturbed model may take any of various forms. To illustrate with some representative examples, the performance value could comprise a metric based on mean-squared loss, cross-entropy loss (e.g., a negative expected value of the cross-entropy loss), exponential loss, or top-capture rate (e.g., a top-capture rate 50), and the bias value could comprise a metric based on a generalization of Cramer von Mises distance or Wasserstein distance between subpopulation-specific distributions of predictions (e.g., a CM₁, CM₂, Wassertein-1 or Wassstein-2 distance), AIR (e.g., a LOG-AIR or AIR50 metric), or Kolmogorov-Smirnov, among other possible examples of performance and bias values that may be determined for each respective instance of the perturbed model. In this respect, it will be appreciated that the performance and bias values determined by the perturbed-model selection component 212 may be similar to the values produced by the error and bias terms of the objective function for the perturbed model, and the perturbed-model selection component 212 may determine these performance and bias values in a similar manner to that described above in connection with the objective function, although it should be understood the perturbed-model selection component 212 need not determine the same types of performance and bias values as those determined for the objective function.

Further, in practice, the performance and bias values for each respective instance of the perturbed model may be determined utilizing a set of data records containing feature values for the machine learning model's input set of features, corresponding ground-truth values for the machine learning model's target variable, and corresponding additive-explanation values determined using a model explanability technique—such as training records from the training dataset or “test” records that were split from the training records prior to the training of the machine learning model, among other possibilities.

The function of determining the respective pair of performance and bias values for each respective instance of the perturbed model may take other forms as well.

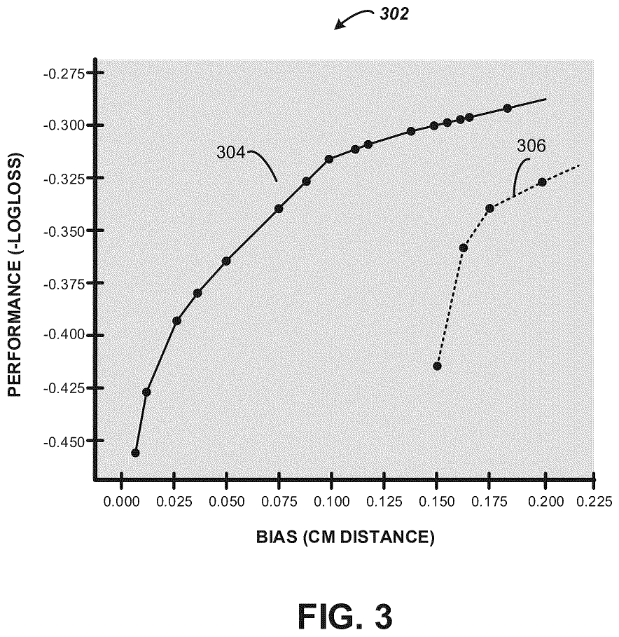

To illustrate with an example, FIG. 3 shows a two-dimensional plot 302 of the performance and bias values that may be determined for a collection of perturbed-model instances, where the x-axis represents bias values that are based on a Cramer von Mises distance and the y-axis represents performance values that are based on cross-entropy loss (e.g., −logloss values). Within this two-dimensional plot 302, a first curve 304 is shown for a first example collection of perturbed-model instances that have been created in accordance with the disclosed technology, where the first curve 304 runs through points representing the respective pairs of performance and bias values that are determined for the first example collection of perturbed-model instances. Additionally, within this two-dimensional plot 302, a second curve 306 is shown for a second example collection of perturbed-model instances that have been created in accordance with previously-existing technology, where the second curve 306 runs through points representing the respective pairs of performance and bias values that are determined for the second example collection of perturbed-model instances.

As can been seen in FIG. 3, the disclosed technology achieves significant improvements over the previously-existing technology with respect to the performance and bias values of the perturbed model. In particular, at the same level of performance, the first example collection of perturbed-model instances exhibits significantly less bias than the second example collection of perturbed-model instances across, and correspondingly, at the same level of bias, the first example collection of perturbed-model instances exhibits significantly better performance than the second example collection of perturbed-model instances.

The performance and bias values that are determined for the instances of the perturbed model produced by the disclosed technology may take various other forms as well.

After determining the respective pair of performance and bias values for the respective instances of the perturbed model, the perturbed-model selection component 212 may then apply certain selection logic to the performance and bias values for the respective instances of the perturbed model in order to select, from the respective instances of the perturbed model, the given instance of the perturbed model having the one given set of perturbation coefficients. The selection logic that is utilized to select the given instance of the perturbed model having the one given set of perturbation coefficients may take any of various forms.

For instance, as one possibility, the selection logic may encode a threshold level of acceptable bias for the perturbed model and define a selection process whereby the perturbed-model selection component 212 limits its analysis to instances of the perturbed model that do not exceed the threshold level of acceptable bias and selects whichever of those instances has the best performance. For example, the perturbed-model selection component 212 may be configured to identify whichever instance of the perturbed model has a bias value that is closest to the threshold level of acceptable bias without exceeding it, as that is expected to be the instance of the perturbed model below the threshold level of bias that has the best performance.

As another possibility, the selection logic may encode a threshold level of acceptable performance of the perturbed model and define a selection process whereby the perturbed-model selection component 212 limits its analysis to instances of the perturbed model that do not fall below the threshold level of acceptable performance and selects whichever of those instances has the least bias. For example, the perturbed-model selection component 212 may be configured to identify whichever instance of the perturbed model has a performance that is closest to the threshold level of acceptable performance without falling below it, as that is expected to be the instance of the perturbed model above the threshold level of performance that has the least bias.

The selection logic that is applied by the perturbed-model selection component 212 in order to select the given instance of the perturbed model may take various other forms as well, including but not limited to the possibility that the selection logic may utilize different types of performance and/or bias metrics as the basis for selecting the given instance of the perturbed model and/or that the selection logic may evaluate other factors in addition to bias and performance.

In some implementations, it is also possible that the perturbed-model selection component 212 could expand the collection of perturbed-model instances that are evaluated for possible selection beyond those that include the respective sets of candidate values for the perturbation coefficients produced during the training process. For instance, in addition to creating the instances of the perturbed model that include the respective sets of candidate values for the perturbation coefficients produced during the training process, the perturbed-model selection component 212 could create other “intervening” instances of the perturbed model and then include those other intervening instances of the perturbed model in the collection of perturbed-model instances that are evaluated for possible selection based on their performance and bias values. The function of creating these other intervening instances of the perturbed model may take any of various forms.

As one possibility, the function of creating other intervening instances of the perturbed model could involve (i) selecting a target bias value for the perturbed model, (ii) identifying the already-created instance of the perturbed model that achieves the largest bias value which remains less than the target bias value, where that instance is denoted as g₁, (iii) identifying the already-created instance of the perturbed model that achieves the smallest bias value which remains greater than target bias value, where that instance is denoted as g₂, (iv) evaluating the bias and performance of all models g̅(x; tⱼ):=(1−tⱼ)·g₁+tⱼ·g₂=\tilde{g}(x; α(tⱼ), j∈{0, . . . , k} where t₁, . . . tₖ∈[0,1], which will have a bias performance trade-off above the linear segment describing the intervening instance between g₁ and g₂, and (v) selecting the value of tⱼ which achieves the bias value closest to our target bias value, which is denoted as t*. In this respect, the perturbation coefficients α(t*) are given as:

$${α}_{i} ( {t}^{*} ) = ( 1 - {t}^{*} ) \cdot {α}_{i}^{( 1 )} + {t}^{*} {α}_{i}^{( 2 )} ,$$

where

$${α}_{i}^{( 1 )} and {α}_{i}^{( 2 )}$$

correspond to the i^{th} perturbation coefficient of the perturbed model g₁ and g₂ respectively and i∈{0, 1, . . . , n}.

As another possibility, the function of creating other intervening instances of the perturbed model could involve constructing a linear segment of intermediate perturbed-model instances by applying the function g̅(x; α)=(1−α)·g(x)+a·\tilde{g}(x; α_{*}), where g(x) is the original trained model (regressor or a raw probability score), \tilde{g}(x; α_{*)} is a given instance of the perturbed model created based on a previously-determined set of candidate values for the perturbation coefficients, and a∈[0,1]. In this respect, if

$$\tilde{g} ( x ; {α}_{*} ) = g ( x ) - ( {\sum }_{i = 1}^{n} {α}_{* i} {h}_{i} ( x ; g ) + {α}_{0} ) ,$$

then the linear segment of intermediate perturbed-model instances can be represented as:

$$\overline{g} ( x ; α ) = g ( x ) - a \cdot ( {\sum }_{i = 1}^{n} {α}_{* i} {h}_{i} ( x ; g ) + {α}_{0} ) .$$

This approach could be applied to each of the already-created instances of the perturbed model that include the respective sets of candidate values for the perturbation coefficients produced by the trainable-object training component 210, or a subset thereof. It should also be understood that, in an alternative embodiment, the trainable-object training component 210 could be configured to carry out a smaller number of training rounds using a smaller number of candidate bias-coefficient values, which would produce a smaller number of different sets of candidate values for the perturbation coefficients and corresponding instances of the perturbed model, and this approach could then be utilized to expand that smaller number of perturbed-model instances. In fact, it is theoretically possible that the trainable-object training component 210 could be configured to carry out as a little as a single training round (e.g., using a single bias-coefficient value at the larger end of the possible range of values) that results in a single set of candidate values for the perturbation coefficients and a single perturbed-model instance, and the perturbed-model selection component 212 could then utilize this approach to create a linear segment of intermediate perturbed-model instances based on that single perturbed-model instance. However, in practice, the perturbed-model instances that are produced using such an approach will likely provide a less optimized performance-bias tradeoff than perturbed-model instances produced through multiple rounds of training, so that needs to be taken into account when deciding whether to implement this alternative embodiment.

The function of creating other intervening instances of the perturbed model could take other forms as well.

The functionality of the perturbed-model selection component 212 may take other forms as well.

After the given instance of the perturbed model having the one given set of perturbation coefficients is selected by the perturbed-model selection component 212, that given instance of the perturbed model may be output by the example software-based pipeline 200 as a fairer version of the trained machine learning model that can be utilized in place of the original version of the trained machine learning model in order to achieve improved fairness relative to the original version of the trained machine learning model while still maintaining an acceptable level of performance.

As one possible example, the given instance of the perturbed model that is output by the example software-based pipeline 200 as the fairer version of a regressor type of trained machine learning model g(x) may be represented as:

$$\tilde{g} ( x ; {α}^{*} ) = g ( x ) - ( {\sum }_{i = 1}^{n} {α}_{i}^{*} {h}_{i} ( x ; g ) + {α}_{0}^{*} )$$

where g(x; α*) represents the fairer version of the regressor type of trained machine learning model, g(x) represents the trained machine learning model, x represents a set of feature values for the trained machine learning model's input set of features, hᵢ(x; g) represents the additive explanation for the i^{th} feature from the input set of features (for the output of g(x)), n represents the number of features in the input set of features,

$${α}_{i}^{*}$$

represents a respective perturbation coefficient that is applied to the additive explanation for the i^{th} feature,

$${\sum }_{i = 1}^{n} {α}_{i}^{*} {h}_{i} ( x ; g )$$

represents a summation of the coefficient-adjusted additive explanations across the input set of features, and

$${α}_{0}^{*}$$

represents an additional perturbation coefficient that is added to the summation.

As another possible example, the given instance of the perturbed model that is output by the example software-based pipeline 200 as the fairer version of a classification type of trained machine learning model f(x) may be represented as:

$$\tilde{f} ( x ; α ) = σ ( \tilde{g} ( x ; {α}^{*} ) ) = σ ( g ( x ) - ( {\sum }_{i = 1}^{n} {α}_{i}^{*} {h}_{i} ( x ; g ) + {α}_{0}^{*} ) ) ,$$

where \tilde{f}(x; α*) represents the fairer version of the classification type of trained machine learning model, σ represents a logistic function (or sometimes more broadly referred to as an activation function), and the rest of the terms are the same as those described in the preceding example.

The fairer version of the trained machine learning model may take various other forms as well.

In turn, the fairer version of the trained machine learning model that is output by the example software-based pipeline 200 may then be deployed for execution by the computing platform 102 and/or some other computing platform, and may thereafter be utilized to render predictions of the given type for individuals or other entities from a population comprising distinct subpopulations that give rise to bias concerns (e.g., subpopulations defined based on gender, race, age, sexual orientation, religion, marital status, etc.). For instance, the computing platform 102 and/or some other computing platform may begin executing the fairer version of the trained machine learning model by providing it with input records for individuals or other entities from a population comprising distinct subpopulations that give rise to bias concerns and thereby causing it to render predictions of the given type for such individuals or other entities.

As one possible example to illustrate, the fairer version of the trained machine learning model may function to render predictions related to whether a financial institution should extend a particular type of service (e.g., a financial service such as a loan, a credit card account, a bank account, or the like) to individuals or other entities, where such predictions may take the form of classification scores (e.g., likelihood values) that are compared against a classification threshold in order to render binary decisions of whether or not the financial institution should extend the particular type of service to such individuals or other entities.

The fairer version of the trained machine learning model may be configured to render predictions of various other types as well.

Further, in practice, the functionality for executing the fairer version of the trained machine learning model that is produced by the software-based pipeline 200 in order to render a prediction for a given input record comprising a set of feature values for the trained machine learning model's input set of features may involve (i) providing the set of feature values and a corresponding set of additive-explanation values that quantify the respective contributions of the original model's input set of features to the original model's output for the given input record as input to the fairer version of the trained machine learning model (where the set of feature values is provided as input to the original model that is included as one term of the fairer model and the set of additive-explanation values is provided as input to the perturbed version of the additive explanations that is included as another term of the fairer model) and (ii) thereby causing the fairer version of the trained machine learning model to output a prediction for the input record.

In this respect, depending on the implementation, the set of additive-explanation values for the input record could be determined in a few different ways. For instance, as one possibility, the set of additive-explanation values for the input record could be determined by using a model explainability technique to determine the set of additive-explanation values that quantify the respective contributions of the trained machine learning model's input set of features to the trained machine learning model's output for the input record—which could be performed in conjunction with the execution of the original version of the trained machine learning model that is included as the first term of the fairer version of the trained machine learning model. Alternatively, as another possibility, the set of additive-explanation values for the input record could be determined by (i) accessing pre-determined sets of additive-explanation values for comparable data records (e.g., data records comprising comparable sets of feature values), such as sets of additive-explanation values that have been pre-determined by the training-data updating component 206 for training and/or test records as described above, and then (ii) using the pre-determined sets of additive-explanation values for the comparable data records as a basis for determining the set of additive-explanation values for the input record (e.g., by applying a technique for determining an unknown value from other known values, such as interpolation, kNN imputation, or the like).

The functionality for executing the fairer version of the trained machine learning model may take various other forms as well.

In line with the discussion above, the fairer version of the trained machine learning model that is produced by the example software-based pipeline 200 may also be explainable, in that the fairer version of the trained machine learning model is capable of having its predictions explained in terms of explanation values that quantify the contributions of the input set of features to the predictions output by the fairer version of the trained machine learning model.

In accordance with the present disclosure, a set of fairer-model explanation values that quantify contributions of the input set of features to the output of the fairer version of the trained machine learning model for an input record may be determined based on (i) a set of original-model explanation values that quantify the respective contributions of the trained machine learning model's input set of features to the output of the original version of the trained machine learning model for the input record, and (ii) the set of perturbation coefficients included in the fairer version of the trained machine learning model. In this respect, the set of original-model explanation values may be the set of additive-explanation values that was previously determined for the input record during execution of the fairer version of the trained machine learning model, or may a set of original-model explanation values that is separately determined at the time that the set of fairer-model explanation values are determined for the input record (e.g., in a scenario where the set of fairer-model explanation values is determined after execution of the fairer model and the set of additive-explanation values determined for the input record during execution of the fairer model are not retained), among other possibilities.

For instance, in a scenario where the fairer version of the trained machine learning model takes the form of either

$$\tilde{g} ( x ; {α}^{*} ) = g ( x ) - ( {\sum }_{i = 1}^{n} {α}_{i}^{*} {h}_{i} ( x ; g ) + {α}_{0}^{*} )$$

(for a regressor type of model) or

$$\tilde{f} ( x ; {α}^{*} ) = σ ( g ( x ) - ( {\sum }_{i = 1}^{n} {α}_{i}^{*} {h}_{i} ( x ; g ) + {α}_{0}^{*} ) )$$

(for a classification type of model) as in the representative examples described above, the explanation values for a given prediction that is output by the fairer version of the trained machine learning model for a given input record may be determined using the following function:

$$\tilde{h} ( x ; \tilde{g} ( \cdot ; {α}^{*} ) ) := ( ( 1 - {α}_{1}^{*} ) {h}_{1} ( x ; g ) , ( 1 - {α}_{2}^{*} ) {h}_{2} ( x ; g ) , … , ( 1 - {α}_{n}^{*} ) {h}_{n} ( x ; g ) ) ,$$

where \tilde{h}(x; \tilde{g}(⋅; α*)) represents a set of additive (and centered) explanation values for a prediction that is output by the fairer model \tilde{g}(x; α*) for an input record x comprising a set of feature values for the input set of features of the original model g(x), hₙ(x; g) represents an individual explanation value that quantifies a contribution of the n^{th} feature of the original model g(x) to the original model's output for the input record x, αₙ* represents the respective perturbation coefficient that is included in the fairer model g(x; α*) for the additive explanation of the n^{th} feature of the original model g(x), and n represents the number of features in the original model g(x) (and thus the fairer model \tilde{g}(x; α*)).

Based on the foregoing, it will be appreciated that the respective explanation value for each respective feature of the fairer version of the trained machine learning model comprises a perturbed version of the respective explanation value that would otherwise be determined for the respective feature of the original version of the trained machine learning model.

The functionality for explaining the predictions output by the fairer version of the trained machine learning model may take other forms as well.

Certain variations and/or extensions of the pipeline functionality described above may also be possible.

For instance, one possible variation and/or extension of the pipeline functionality described above may involve utilizing a dimensionality-reduction technique to reduce the dimensionality of the variables and corresponding coefficients in the trainable object to something smaller than the number of features included in the trained machine learning model's input set of features. This functionality may take any of various forms and be implemented in any of various manners.

As one possible implementation, after determining the respective sets of additive-explanation values for at least a subset of the training records in the training dataset, the training-data updating component 206 may function to apply a dimensionality-reduction technique to the respective sets of additive-explanation values, which may involve (i) determining a new, reduced space of variables having a dimensionality that is smaller than a number of features included in the trained machine learning model's input set of features (and thus the space of explanation variables) and (ii) transforming the respective sets of additive-explanation values into respective sets of values for the reduced space of variables.

The dimensionality-reduction technique that is applied by the training-data updating component 206 may take any of various forms. For instance, as one possibility, the dimensionality-reduction technique may take the form of a principal component analysis (PCA) technique that produces a new, reduced space of uncorrelated variables referred to as “principal components” and transforms the values for the original variables into values for the principal components. As another possibility, the dimensionality-reduction technique may take the form of sparse PCA, which is a variation of PCA. The dimensionality-reduction technique may take other forms as well.

Further, the number of dimensions in the reduced space of variables may take any of various forms, and as one representative example, the number of dimensions may be less than 100 (e.g., 40-50 dimensions). In this respect, the number of dimensions may be determined based on an evaluation of how much variance is lost by truncating the representation and/or based on the size of the dataset, among other possible factors.

In an embodiment where the training-data updating component 206 applies a dimensionality-reduction technique to the respective sets of additive-explanation values, the trainable-object definition component 208 may define a trainable object (e.g., a neural network) having (i) an input that comprises a set of values for the reduced space of variables and (ii) an output that comprises a perturbed version of the reduced space of variables, where the coefficients included the trainable object are a reduced-dimensionality version of the perturbation coefficients that are included in the perturbed model. And in turn, during the training of the trainable object, the trainable-object training component 210 may determine candidate values for the reduced-dimensionality version of the perturbation coefficients (rather than the perturbation coefficients themselves) using the objective function for the perturbed model, the trainable object, and the respective sets of values for the reduced space of variables that are determined for the training records. In this respect, after the respective sets of candidate values for the reduced-dimensionality version of the perturbation coefficients are determined utilizing the objective function, the trainable-object training component 210 (or some other component) may then transform the candidate values for the reduced-dimensionality version of the perturbation coefficients into values for the perturbation coefficients.

Notably, utilizing a dimensionality-reduction technique to reduce the dimensionality of the variables and corresponding coefficients of the trainable object in the manner described above may provide certain advantages relative to utilizing the additive explanations as the input to the trainable object. For instance, reducing the dimensionality of the variables and corresponding coefficients of the trainable object may improve the performance of the training process for the trainable object in certain ways, including by reducing the time that each training round takes, reducing the extent of compute resources require to carry out each training round, and/or reducing the risk of overfitting the trainable object during the training process. However, the tradeoff for these benefits is that, at least in some scenarios, reducing the dimensionality of the variables and corresponding coefficients of the trainable object may produce candidate values for the perturbation coefficients that are less optimized than the perturbation coefficients that would be produced if the trainable object were to include the additive explanations and corresponding perturbation coefficients. Thus, these benefits and potential drawbacks need to be weighed against each other when deciding whether to reduce the dimensionality of the variables and corresponding coefficients of the trainable object.

Another possible variation and/or extension of the pipeline functionality described above may involve using a different version of the training dataset for the training of the trainable object relative to the version of the training dataset used for training the machine learning model so as to reduce the risk of overfitting the trainable object, which could lead to less-than-optimal perturbation coefficients. For instance, the example software-based pipeline 200 may employ a holdout technique and/or a technique for introducing noise into the training dataset in order to produce different versions of the training dataset that can be utilized by the example software-based pipeline 200 to carry out the two different training processes.

Yet possible variation and/or extension of the pipeline functionality described above may involve using an objective function comprising an error term that evaluates the perturbed model's predictions relative to the original machine learning model's predictions rather the ground-truth values (e.g. by determining the binary cross-entropy between the perturbed model's predictions and the original machine learning model's predictions) so as to reduce the risk of overfitting the trainable object, which could lead to less-than-optimal perturbation coefficients.

Still another possible variation and/or extension of the pipeline functionality described above may involve training the trainable object using either another variant of gradient descent or an optimization process other than gradient descent.

Other variations and/or extensions of the pipeline functionality described above may be possible as well.

Further, the example software-based pipeline 200 described above could take other forms. For instance, as one possibility, the example software-based pipeline 200 may include other components that are not shown or described above but may nevertheless facilitate the functionality disclosed herein. As another possibility, certain of the components shown and described above could be combined together or separated out into multiple sub-components. As yet another possibility, certain of the components shown and described above may perform additional or different functionality from what is described above. Other variations of the example software-based pipeline 200 are possible as well.

Further yet, as noted above, it is possible that the components of the example software-based pipeline 200 could be distributed across multiple different computing platforms. For instance, as one possibility, model training component 202 could be hosted on a separate computing platform from the rest of the components of the example software-based pipeline 200 (e.g., in a scenario where the machine learning model is trained by one organization and then provided to a different organization that is tasked with creating the fairer version of the trained machine learning model). As another possibility, the component(s) that execute the fairer version of the trained machine learning model and generate explanations for the fairer version of the trained machine learning model could be hosted on a separate computing platform from the rest of the components of the example software-based pipeline 200 (e.g., in a scenario where the fairer version of the trained machine learning model is created by one organization and then provided to a different organization that is tasked with executing the fairer version of the trained machine learning model and generating explanations therefor). Other arrangements of the components of the example software-based pipeline 200 are possible as well.

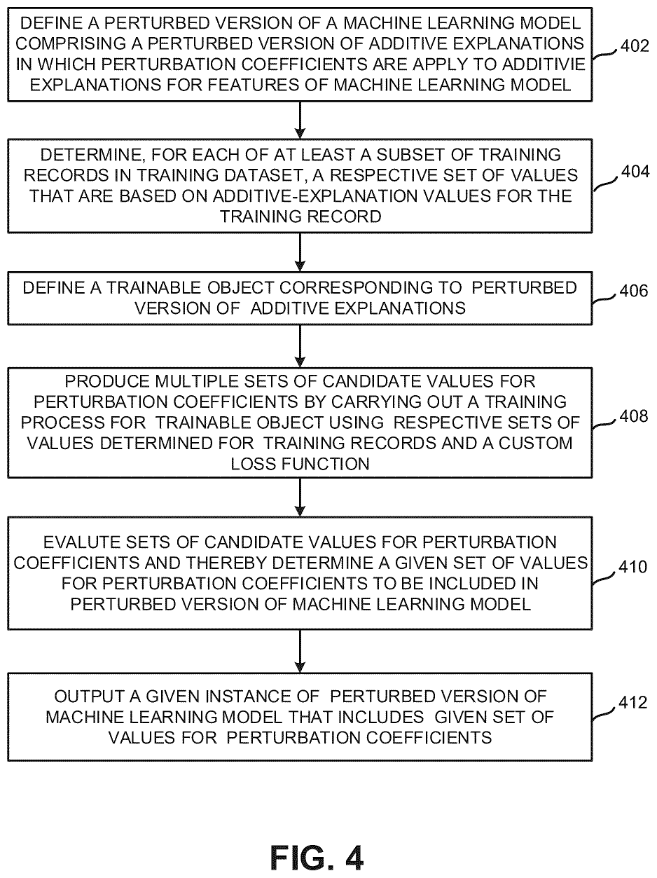

One possible example of functionality 400 that may be carried out in accordance with the disclosed technology will now be described with reference to the flow chart of FIG. 4. In practice, the functionality 400 of FIG. 4 may be encoded in the form of program instructions that are executable by one or more processors of a computing platform, and for purposes of illustration, the functionality 400 of FIG. 4 is described as being carried out by the computing platform 102 of FIG. 1, but it should be understood that the functionality 400 of FIG. 4 may be carried out by any one or more computing platforms that are capable of being installed with software for performing the functions described below. Further, it should be understood that the functionality 400 of FIG. 4 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

As shown in FIG. 4, the functionality 400 may begin at block 402 with the back-end computing platform 102 defining a perturbed version of a machine learning model that was trained by applying a machine learning process to a training dataset, where (i) the machine learning model is configured to receive values for an input set of features and output a prediction and (ii) perturbed version of the machine learning model comprises a perturbed version of additive explanations for at least a subset of the input set of features in which the additive explanations are perturbed by a set of perturbation coefficients. In this respect, the machine learning model and the perturbed version thereof may take any of various forms, including any of the various forms described above. Further, in practice, the function of defining the perturbed version of the machine learning model may be carried out based on configuration information for the perturbed version of the machine learning model that is provided as input to the functionality 400, among other possibilities. For instance, the back-end computing platform 102 may function to receive configuration information for the perturbed version of the machine learning model (e.g., configuration information that is specified by a user and/or contained within a definition file that is created by some other software component) and then define (e.g., initialize and/or instantiate) the perturbed version of the machine learning model based on that received configuration information.

At block 404, the back-end computing platform 102 may determine, for each of at least a subset of the training records in the training dataset, a respective set of values that are based on additive-explanation values for the training record. In line with the discussion above, the respective set of values that are determined for each of the subset of training records may comprise either (i) additive-explanation values that are determined for the training record using a model explanability technique or (ii) a dimensionality-reduced version of the additive-explanation values that are determined for the training record using the model explanability technique.

At block 406, the back-end computing platform 102 may also define a trainable object corresponding to the perturbed version of the additive explanations, where the trainable object is configured to (i) receive an input set of values that are based on additive-explanation values for an input record and (ii) produce and output a perturbed version of the input set of values by applying a set of coefficients to the input set of value. In this respect, the trainable object may take any of various forms, including any of the various forms described above (e.g., a neural network implemented using a machine learning framework that provides for automatic differentiation). Further, in practice, the function of defining the trainable object may be carried out based on configuration information for the trainable object that is provided as input to the functionality 400, among other possibilities. For instance, the back-end computing platform 102 may function to receive configuration information for the trainable object (e.g., configuration information that is specified by a user and/or contained within a definition file that is created by some other software component) and then define (e.g., initialize and/or instantiate) the trainable object based on that received configuration information.

At block 408, the back-end computing platform 102 may then produce multiple sets of candidate values for the perturbation coefficients by carrying out a training process for the trainable object using the respective sets of values determined for the training records and an objective function for the perturbed version of the machine learning model that includes (i) an error term that quantifies the error of the perturbed version of the machine learning model, (ii) a bias term that quantifies the bias of the perturbed model with respect to certain distinct subpopulations, and (iii) a bias coefficient that is applied to the bias term (which as noted above may be referred to as a custom loss function), where (a) the perturbed version of the additive explanations is replaced by the trainable object during evaluation of the objective function and (b) the training process involves multiple training rounds that are each carried out using a respective candidate value of the bias coefficient and each produces a respective set of candidate values for the perturbation coefficients. In this respect, the training process for the trainable object may take any of various forms, including any of the various forms described above (e.g., a training process involve training rounds that are each carried out by a gradient descent process such as stochastic gradient descent to minimize the objective function).

At block 410, the back-end computing platform 102 may next determine a given set of values for the perturbation coefficients that are to be included in the perturbed version of the machine learning model based on an evaluation of the multiple sets of candidate values for the perturbation coefficients. In this respect, the evaluation of the multiple sets of candidate values for the perturbation coefficients may take any of various forms, including but not limited to any of the various forms described above (e.g., evaluating performance and bias of multiple different instances of the perturbed version of the machine learning model that each includes a different set of candidate values for the perturbation coefficients).

Lastly, at block 412, the back-end computing platform 102 may output a given instance of the perturbed version of the machine learning model that includes the given set of values for the perturbation coefficients. In this respect, the given instance of the perturbed version of the machine learning model may take any of various forms, including any of the various forms described above.

As noted, the functionality 400 may take various other forms as well. For instance, it is possible that the functionality 400 may include additional and/or different functions than those shown in FIG. 4, including but not limited to any additional and/or different functions that are described above.

While the disclosed functionality is described above in the context of embodiments for producing a fairer version of trained machine learning model based on a perturbed model that is defined to include a perturbed version of the additive explanations for the trained machine learning model's input set of features, in other embodiments, the disclosed functionality could be utilized to produce a fairer version of a trained machine learning model based on a perturbed model that is defined to include a perturbed version of the trained machine learning model's input set of features in which respective perturbation coefficients (which could be referred to more specifically as “feature coefficients”) are applied to the features of the trained machine learning model.

In these other embodiments, the machine learning model that is trained by the model training component 202 could comprise any type of machine learning model having an input comprising values for an input set of features and an output comprising a prediction that could give rise to bias concerns—which could any of the example types of machine learning models discussed above.

Further, in these other embodiments, the perturbed model comprising the perturbed version of the trained machine learning model's input set of features that is defined by the perturbed-model definition component 204 could have a similar form to the example perturbed models discussed above, but with the additive explanations for the input set of features replaced by the input set of features, the perturbation coefficients for the additive explanations replaced by perturbation coefficients for the input set of features (i.e., feature coefficients), and the additional perturbation coefficient α₀ removed (i.e., set to zero). For example, if the trained machine learning model is a regressor type of machine learning model represented by g(x), then such a perturbed model may be represented as:

$$\tilde{g} ( x ; α ) = g ( x ) - {\sum }_{i = 1}^{n} {α}_{i} {x}_{i} ,$$

where \tilde{g}(x; α) represents the perturbed regressor type of model, g(x) represents the original version of the trained machine learning model, x represents a given input set of feature values for the trained machine learning model's input set of feature variables (which has a dimensionality equal to the number of feature variables included in the input set), α represents the perturbation coefficients that are to be applied to the features (which also has a dimensionality equal to the number of features in the trained machine learning model), xᵢ represents a feature value from the given set of feature values for the i^{th} feature in the input set of feature variables, αᵢ represents the respective perturbation coefficient that is to be applied to the respective feature value for the i^{th} feature, and n represents the number of features in the trained machine learning model.

As another example, if the trained machine learning model is a classification type of machine learning model of the form f(x)=σ(g(X)) where ∝ represents a logistic function and g(x) represents a regressor, then such perturbed model may be represented as:

$$\tilde{f} ( x ; α ) = σ ( \tilde{g} ( x ; α ) ) = σ ( g ( x ) - {\sum }_{i = 1}^{n} {α}_{i} {x}_{i} ) ,$$

where \tilde{f}(x; α) represents the perturbed classification type of model.

As with the perturbation coefficients included in the example perturbed models comprising the perturbed version of the additive explanations, the perturbation coefficients included in these example perturbed models comprising a perturbed version of the trained machine learning model's input set of features could either have (i) all unknown, non-zero values that are determined during training of the training object, (ii) a mixture of unknown, non-zero values for some features and zero values for other features (which effectively amounts to removing certain features from the perturbed model), (iii) a mixture of unknown, non-zero values for some features and known, fixed non-zero values for other features, or (iv) a mixture of all three of unknown, non-zero values for some features, zero values for other features, and known, fixed non-zero values for still other features.

A perturbed model comprising a perturbed version of the trained machine learning model's input set of features could take various other forms as well, including but not limited to the possibility that the perturbed model comprising the perturbed version of the trained machine learning model's input set of features could include an additional perturbation coefficient α₀ that is added to or subtracted from the summation of the coefficient-adjusted features.

Further yet, in these other embodiments, the trainable object that is defined by the trainable-object definition component 208 could have a similar form to the example trainable objects discussed above, but with the additive explanations replaced by the input set of features, the perturbation coefficients for the additive explanations replaced by perturbation coefficients for the input set of features, and the additional perturbation coefficient α₀ removed such that the trainable object represents the perturbed version of the trained machine learning model's input set of features and the perturbation coefficients for the features are the trainable parameters. For instance, one example of such trainable object may take the form of a neural network that may be represented as follows:

$$𝒩 ( x ; α ) = ( input ) ( {x}_{1} , {x}_{2} , … , {x}_{n} ) \to ( output ) {\sum }_{i = 1}^{n} {α}_{i} {x}_{i} ,$$

where [symbol] (x; α) represents the neural network, x=(x₁, x₂, . . . , xₙ) represents a given set of feature values for the trained machine learning model's input set of features, xᵢ represents a feature value from the given set of feature values for the i^{th} feature in the input set of feature variables, αᵢ represents the respective feature coefficient that is to be applied to the respective feature value for the i^{th} feature, and n represents the number of features in the trained machine learning model.

Still further, in these other embodiments, the training process for the trainable object that is carried out by the trainable-object training component 210 may have a similar form to the training process described above, but with the training process determining candidate values for the perturbation coefficients for the features (rather than the additive explanations) using data records comprising sets of feature values for the input set of features (rather than sets additive-explanation values) along with corresponding ground-truth and sub-population values (e.g., training records that were used to train the machine learning model, test records that were split from the training records prior to training, and/or modified versions thereof). More particularly, in line with the discussion above, the trainable-object training component 210 may begin by updating the objective function for the perturbed model to replace the perturbed version of the trained machine learning model's input set of features with the trainable object that is defined by the trainable-object definition component 208, and may then engage in multiple different “rounds” of training the trainable object for the multiple different bias-coefficient values in the defined set of bias-coefficient values, where each such training round may involve (i) defining a respective instance of the objective function to utilize for the training round, and (ii) determining a respective set of candidate values for the perturbation coefficients that minimizes the respective instance of the objective function. As a result of this functionality, the trainable-object training component 210 may determine multiple different sets of candidate values for the perturbation coefficients corresponding to the different candidate bias-coefficient values.

Still further yet, in these other embodiments, the model-selection functionality carried out by the perturbed-model selection component 212 may have a similar form to the model-selection functionality described above, but with the different instances of the perturbed model comprising different candidate sets of values for the perturbation coefficients that are applied to the trained machine learning model's input set of features rather than perturbation coefficients that are applied to the additive explanations for the input set of features. More particularly, in line with the discussion above, the perturbed-model selection component 212 may (i) create respective instances of the perturbed model that each includes a respective set of candidate values for the perturbation coefficients to be applied to the features (e.g., by inserting the respective set of candidate values for the perturbation coefficients into the perturbed model), (ii) determining respective pairs of performance and bias values for the respective instances of the perturbed model, and (iii) apply certain selection logic to the respective pairs performance and bias values determined for the respective instances of the perturbed model in order to select, from the respective instances of the perturbed model, the given instance of the perturbed model having the one given set of perturbation coefficients, which may then be implemented as the fairer version of the trained machine learning model. Further, in line with the discussion above, the perturbed-model selection component 212 may also optionally expand the collection of perturbed-model instances that are evaluated for possible selection beyond those that include the respective sets of candidate values for the perturbation coefficients produced during the training process.

In these other embodiments, after the given instance of the perturbed model having the one given set of perturbation coefficients for the trained machine learning model's input set of features is selected by the perturbed-model selection component 212, that given instance of the perturbed model may be output by the example software-based pipeline 200 as a fairer version of the trained machine learning model that can be utilized in place of the original version of the trained machine learning model in order to achieve improved fairness relative to the original version of the trained machine learning model while still maintaining an acceptable level of performance.

Moreover, in these other embodiments, a prediction for an input record that is output by the fairer version of the trained machine learning model comprising the perturbed version of the input set of features may similarly be explainable. More particularly, a prediction for an input record that is output by the fairer version of the trained machine learning model comprising the perturbed version of the input set of features may be explained in terms of explanation values that are determined based on (i) explanation values for a prediction that is output (or would have been output) by the original version of the trained machine learning model for the input record and (ii) the set of perturbed coefficients included in the fairer version of the trained machine learning model.

For instance, in a scenario where the fairer version of the machine learning model takes the form of

$$\tilde{g} ( x ; α ) = g ( x ) - {\sum }_{i = 1}^{n} {α}_{i} {x}_{i}$$

as in the representative example described above, the explanation values for a given prediction output by the fairer version of the trained machine learning model may be determined using the following function:

$$\tilde{h} ( x ; \tilde{g} ( x ; {α}^{*} ) ) = h ( x ; g ) - {\sum }_{i = 1}^{n} {α}_{i}^{*} h ( x ; {x}_{i} ) ,$$

where \tilde{h}(x; g(x; α*)) represents a set of fairer-model explanation values for a prediction that is output by the fairer model \tilde{g} for a given set of feature values x for the input set of features, h(x; g) represents a set of original-model explanation values for a prediction that is output (or would be output) by the original model g(x) for the given input set of feature values x, h (x; xᵢ) represents an explanation value for the i^{th} feature in the input set of features, αᵢ* represents the respective perturbation coefficient for the i^{th} feature in the input set of features, and n represents the number features in the input set of features.

The other variations and/or extensions of the pipeline functionality described above may also be applicable to these other embodiments.

In still other embodiments, the disclosed functionality could be utilized to produce a fairer version of a trained machine learning model based on a perturbed model that is defined to include a perturbed version of feature-specific transformations for the trained machine learning model's input set of features (either in place of or in combination with the perturbed version of the features) in which respective feature-specific perturbation coefficients are applied to respective feature-specific transformations for the trained machine learning model's input set of features (e.g., feature-specific functions that each take a respective feature's as input and then produce a respective output based on the respective feature's value). To illustrate with a simplified example, if the trained machine learning model is a regressor type of machine learning model represented by g(x) that includes three features {x₁, x₂, x₃}, then such a perturbed model could take the form of:

$$\tilde{g} ( x ; α ) = g ( x ) - [ {α}_{11} {x}_{1} + {α}_{12} {x}_{1}^{2} + {α}_{21} {x}_{2} + {α}_{22} {x}_{2}^{2} + {α}_{31} {x}_{2} + {α}_{32} {x}_{3}^{2} ] ,$$

which includes perturbed versions of both the trained machine learning model's features and feature-specific transformations thereof. However, it should be understood that the feature-specific transformations of the trained machine learning model's features could take various other forms as well.

The disclosed functionality could be utilized to produce a fairer version of a trained machine learning model based on a perturbed model that takes other forms as well.

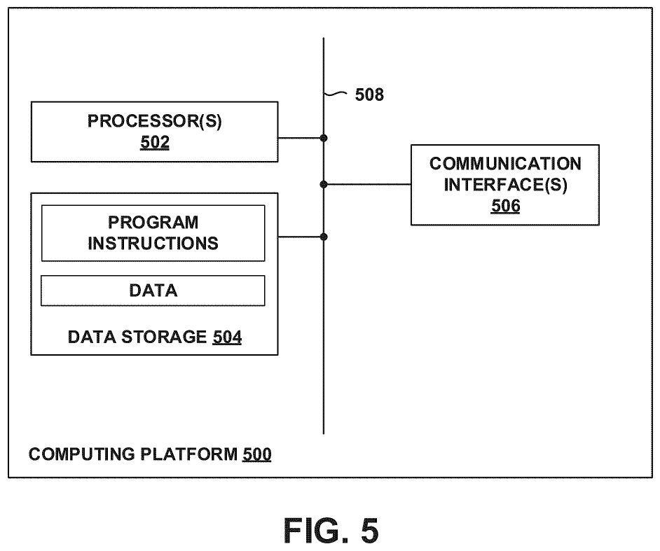

Turning now to FIG. 5, a simplified block diagram is provided to illustrate some structural components that may be included in an example computing platform 500 that may be configured perform some or all of the functions discussed herein for creating a data science model in accordance with the present disclosure. At a high level, computing platform 500 may generally comprise any one or more computer systems (e.g., one or more servers) that collectively include one or more processors 502, data storage 504, and one or more communication interfaces 506, all of which may be communicatively linked by a communication link 508 that may take the form of a system bus, a communication network such as a public, private, or hybrid cloud, or some other connection mechanism. Each of these components may take various forms.

For instance, the one or more processors 502 may comprise one or more processor components, such as one or more central processing units (CPUs), graphics processing unit (GPUs), application-specific integrated circuits (ASICs), digital signal processor (DSPs), and/or a programmable logic device such as a field programmable gate arrays (FPGAs), among other possible types of processing components. In line with the discussion above, it should also be understood that the one or more processors 502 could comprise processing components that are distributed across a plurality of physical computing devices connected via a network, such as a computing cluster of a public, private, or hybrid cloud.

In turn, data storage 504 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 504 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 5, data storage 504 may be capable of storing both (i) program instructions that are executable by processor 502 such that the computing platform 500 is configured to perform any of the various functions disclosed herein (including but not limited to any the functions described above with reference to FIGS. 2-4), and (ii) data that may be received, derived, or otherwise stored by computing platform 500.

The one or more communication interfaces 506 may comprise one or more interfaces that facilitate communication between computing platform 500 and other systems or devices, where each such interface may be wired and/or wireless and may communicate according to any of various communication protocols, examples of which may include Ethernet, Wi-Fi, serial bus (e.g., Universal Serial Bus (USB) or Firewire), cellular network, and/or short-range wireless protocols, among other possibilities.

Although not shown, the computing platform 500 may additionally include or have an interface for connecting to one or more user-interface components that facilitate user interaction with the computing platform 500, such as a keyboard, a mouse, a trackpad, a display screen, a touch-sensitive interface, a stylus, a virtual-reality headset, and/or one or more speaker components, among other possibilities.

It should be understood that computing platform 500 is one example of a computing platform that may be used with the embodiments described herein. Numerous other arrangements are possible and contemplated herein. For instance, other computing systems may include additional components not pictured and/or more or less of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing platform comprising:
at least one network interface for communicating over at least one data network;
at least one processor;
at least one non-transitory computer-readable medium; and
program instructions stored on the at least one non-transitory computer-readable medium that, when executed by the at least one processor, cause the computing platform to:
define a perturbed version of a machine learning model that was trained by applying a machine learning process to a training dataset, wherein the machine learning model is configured to receive values for an input set of features and output a prediction, and wherein the perturbed version of the machine learning model comprises a perturbed version of additive explanations for at least a subset of the input set of features in which the additive explanations are perturbed by a set of perturbation coefficients;
determine, for each of at least a subset of the training records in the training dataset, a respective set of values that are based on additive-explanation values for the training record;
define a trainable object corresponding to the perturbed version of the additive explanations, wherein the trainable object is configured to (i) receive an input set of values that are based on additive-explanation values for an input record and (ii) produce and output a perturbed version of the input set of values by applying a set of coefficients to the input set of values;
produce multiple sets of candidate values for the perturbation coefficients by carrying out a training process for the trainable object using the respective sets of values determined for the training records and an objective function for the perturbed version of the machine learning model that includes (i) an error term that quantifies the error of the perturbed version of the machine learning model, (ii) a bias term that quantifies the bias of the perturbed model with respect to certain distinct subpopulations, and (iii) a bias coefficient that is applied to the bias term, wherein the perturbed version of the additive explanations is replaced by the trainable object during evaluation of the objective function, and wherein the training process involves multiple training rounds that are each carried out using a respective candidate value of the bias coefficient and each produces a respective set of candidate values for the perturbation coefficients;
based on an evaluation of the multiple sets of candidate values for the perturbation coefficients, determine a given set of values for the perturbation coefficients that are to be included in the perturbed version of the machine learning model; and
output a given instance of the perturbed version of the machine learning model that includes the given set of values for the perturbation coefficients.

2. The computing platform of claim 1, wherein the additive explanations for at least the subset of the input set of features comprise additive explanations that are produced using a game-theoretic explainability technique.

3. The computing platform of claim 1, wherein:
the respective set of values that are determined for each of the subset of training records comprises either (i) additive-explanation values that are determined for the training record using a model explanability technique or (ii) a dimensionality-reduced version of the additive-explanation values that are determined for the training record using the model explanability technique;
the input set of values that is received by the trainable object comprises either (i) additive-explanation values that are determined for the input record using the model explanability technique or (ii) a reduced-dimensionality version of the additive-explanation values that are determined for the input record using the model explanability technique; and
the set of perturbation coefficients that is applied by the trainable object comprises either (i) the set of perturbation coefficients or (ii) a dimensionality-reduced version of the set of perturbation coefficients.

4. The computing platform of claim 1, wherein the trainable object comprises a neural network implemented using a machine learning framework that provides for automatic differentiation.

5. The computing platform of claim 1, wherein the machine learning framework comprises a TensorFlow framework.

6. The computing platform of claim 1, wherein each of the multiple training rounds of the training process are carried out by utilizing a gradient descent process to minimize the objective function.

7. The computing platform of claim 6, wherein the gradient descent process comprises a stochastic gradient descent process.

8. The computing platform of claim 1, wherein the evaluation of the multiple sets of candidate values for the perturbation coefficients involves (i) producing multiple instances of the perturbed version of the machine learning model that each has a respective one of the multiple sets of candidate values for the perturbation coefficients and (ii) evaluating performance and bias of the multiple instances of the perturbed version of the machine learning model.

9. The computing platform of claim 1, wherein the given instance of the perturbed version of the machine learning model is explainable.

10. The computing platform of claim 1, further comprising program instructions stored on the at least one non-transitory computer-readable medium that, when executed by the at least one processor, cause the computing platform to:
deploy the given instance of the perturbed version of the machine learning model.

11. The computing platform of claim 10, further comprising program instructions stored on the at least one non-transitory computer-readable medium that, when executed by the at least one processor, cause the computing platform to:
after deploying the given instance of the perturbed version of the machine learning model, utilize the given instance of the perturbed version of the machine learning model to render predictions for individuals or other entities within a population comprising distinct subpopulations; and
for each of at least a subset of the predictions rendered by the given instance of the perturbed version of the machine learning model, utilize a model explainability technique to explain the prediction.

12. A non-transitory computer-readable medium, wherein the non-transitory computer-readable medium is provisioned with program instructions that, when executed by at least one processor, cause a computing platform to:
define a perturbed version of a machine learning model that was trained by applying a machine learning process to a training dataset, wherein the machine learning model is configured to receive values for an input set of features and output a prediction, and wherein the perturbed version of the machine learning model comprises a perturbed version of additive explanations for at least a subset of the input set of features in which the additive explanations are perturbed by a set of perturbation coefficients;
determine, for each of at least a subset of the training records in the training dataset, a respective set of values that are based on additive-explanation values for the training record;
define a trainable object corresponding to the perturbed version of the additive explanations, wherein the trainable object is configured to (i) receive an input set of values that are based on additive-explanation values for an input record and (ii) produce and output a perturbed version of the input set of values by applying a set of coefficients to the input set of values;
produce multiple sets of candidate values for the perturbation coefficients by carrying out a training process for the trainable object using the respective sets of values determined for the training records and an objective function for the perturbed version of the machine learning model that includes (i) an error term that quantifies the error of the perturbed version of the machine learning model, (ii) a bias term that quantifies the bias of the perturbed model with respect to certain distinct subpopulations, and (iii) a bias coefficient that is applied to the bias term, wherein the perturbed version of the additive explanations is replaced by the trainable object during evaluation of the objective function, and wherein the training process involves multiple training rounds that are each carried out using a respective candidate value of the bias coefficient and each produces a respective set of candidate values for the perturbation coefficients;
based on an evaluation of the multiple sets of candidate values for the perturbation coefficients, determine a given set of values for the perturbation coefficients that are to be included in the perturbed version of the machine learning model; and
output a given instance of the perturbed version of the machine learning model that includes the given set of values for the perturbation coefficients.

13. The non-transitory computer-readable medium of claim 12, wherein:
the respective set of values that are determined for each of the subset of training records comprises either (i) additive-explanation values that are determined for the training record using a model explanability technique or (ii) a dimensionality-reduced version of the additive-explanation values that are determined for the training record using the model explanability technique;
the input set of values that is received by the trainable object comprises either (i) additive-explanation values that are determined for the input record using the model explanability technique or (ii) a reduced-dimensionality version of the additive-explanation values that are determined for the input record using the model explanability technique; and
the set of coefficients that is applied by the trainable object comprises either (i) the set of perturbation coefficients or (ii) a dimensionality-reduced version of the set of perturbation coefficients.

14. The non-transitory computer-readable medium of claim 12, wherein the trainable object comprises a neural network implemented using a machine learning framework that provides for automatic differentiation.

15. The non-transitory computer-readable medium of claim 12, wherein each of the multiple training rounds of the training process are carried out by utilizing a gradient descent process to minimize the objective function.

16. A method carried out by a computing platform, the method comprising:
defining a perturbed version of a machine learning model that was trained by applying a machine learning process to a training dataset, wherein the machine learning model is configured to receive values for an input set of features and output a prediction, and wherein the perturbed version of the machine learning model comprises a perturbed version of additive explanations for at least a subset of the input set of features in which the additive explanations are perturbed by a set of perturbation coefficients;
determining, for each of at least a subset of the training records in the training dataset, a respective set of values that are based on additive-explanation values for the training record;
defining a trainable object corresponding to the perturbed version of the additive explanations, wherein the trainable object is configured to (i) receive an input set of values that are based on additive-explanation values for an input record and (ii) produce and output a perturbed version of the input set of values by applying a set of coefficients to the input set of values;
producing multiple sets of candidate values for the perturbation coefficients by carrying out a training process for the trainable object using the respective sets of values determined for the training records and an objective function for the perturbed version of the machine learning model that includes (i) an error term that quantifies the error of the perturbed version of the machine learning model, (ii) a bias term that quantifies the bias of the perturbed model with respect to certain distinct subpopulations, and (iii) a bias coefficient that is applied to the bias term, wherein the perturbed version of the additive explanations is replaced by the trainable object during evaluation of the objective function, and wherein the training process involves multiple training rounds that are each carried out using a respective candidate value of the bias coefficient and each produces a respective set of candidate values for the perturbation coefficients;
based on an evaluation of the multiple sets of candidate values for the perturbation coefficients, determining a given set of values for the perturbation coefficients that are to be included in the perturbed version of the machine learning model; and
outputting a given instance of the perturbed version of the machine learning model that includes the given set of values for the perturbation coefficients.

17. The method of claim 16, wherein:
the respective set of values that are determined for each of the subset of training records comprises either (i) additive-explanation values that are determined for the training record using a model explanability technique or (ii) a dimensionality-reduced version of the additive-explanation values that are determined for the training record using the model explanability technique;
the input set of values that is received by the trainable object comprises either (i) additive-explanation values that are determined for the input record using the model explanability technique or (ii) a reduced-dimensionality version of the additive-explanation values that are determined for the input record using the model explanability technique; and
the set of coefficients that is applied by the trainable object comprises either (i) the set of perturbation coefficients or (ii) a dimensionality-reduced version of the set of perturbation coefficients.

18. The method of claim 16, wherein the trainable object comprises a neural network implemented using a machine learning framework that provides for automatic differentiation.

19. The method of claim 16, wherein each of the multiple training rounds of the training process are carried out by utilizing a gradient descent process to minimize the objective function.

20. The method of claim 16, wherein the evaluation of the multiple sets of candidate values for the perturbation coefficients involves (i) producing multiple instances of the perturbed version of the machine learning model that each has a respective one of the multiple sets of candidate values for the perturbation coefficients and (ii) evaluating performance and bias of the multiple instances of the perturbed version of the perturbation model.
